(19) United States
(12) Patent Application Publication
(10) Pub. No.: US 2016/0026940 A1
(43) Pub. Date: Jan. 28, 2016

(54) METHODS, APPARATUS AND SYSTEMS FOR GENERATING, UPDATING AND EXECUTING A CROP-HARVESTING PLAN

(71) Applicant: Aglytix, Inc., Mankato, MN (US)

(72) Inventor: Jerome Dale Johnson, Waterville, MN (US)

(21) Appl. No.: 14/872,598

(22) Filed: Oct. 1, 2015

Related U.S. Application Data
(63) Continuation-in-part of application No. 13/341,625, filed on Dec. 30, 2011, now abandoned.

(51) Int. Cl. G06Q 10/06

(52) U.S. Cl. CPC G06Q 10/063

(57) ABSTRACT

Crop-harvesting plans automatically generated based on crop-harvesting information received from a variety of sources, such as a user, remote sensor, database, data feed and/or a social network. The crop-harvesting plans may dynamically aid farmers and other production agriculture professionals when determining a crop-harvesting plan and then implementing that crop-harvesting plan. Crop-harvesting plans may include a variety of recommended crop-harvesting practices, logistics, sequences and projected outcomes for the implementation of the recommended crop-harvesting plan.

### CROSS-REFERENCE TO RELATED APPLICATION(S)

This application is a Continuation-in-Part of U.S. patent application Ser. No. 13/341,625 filed Dec. 30, 2011, herein incorporated by reference in its entirety.

### FIELD OF THE INVENTION

The present invention relates to methods, graphical user interfaces (GUI), computer-readable media, data, and systems for dynamically generating, updating, and executing a crop-harvesting plan.

### BACKGROUND

Typically, farmers intuitively determine their harvesting strategies based on available resources, past experiences, local knowledge, and opinions. In some instances a farmer may hire a consultant or a supplier to assist in the development of a harvesting plan. However, these practices often result in outcomes that are less than what is possible because they fail to consider many aspects of crop-harvesting when the farmer makes his or her decisions, including efficient utilization of resources and time available, logistics, including the organization and movement of equipment, people, and supplies, field and crop conditions, field and crop characteristics, constraints, and other factors that contribute to optimizing crop harvesting and achieving the desired outcomes. Additionally, intuitive harvesting strategies are not scalable or measurable for today's large-scale production agricultural businesses that employ large numbers of workers, pieces of equipment, and suppliers, to harvest the crops across farms and fields located potentially hundreds of miles apart. In addition, intuitive harvesting strategies do not leverage all of the data and technical capabilities currently available, such as remote sensing, social networking, or other capabilities that are not known at this time but will certainly become available over time. Intuitive harvesting strategies do not adapt well to unplanned events such as inclement weather, personnel issues, supply shortages, etc. Also, intuitive harvesting plans suffer because it is difficult for farmers to modify their traditional habits and practices in the face of broader unplanned events such as those caused by climate changes.'

Finally, when planning and executing harvesting plans, farmers are highly dependent on the performance of their suppliers as they provide and deliver the products and services necessary to achieve the desired harvesting outcomes. Farmers are also dependent on the buyers of their products who need to be prepared to receive and process the harvested crops as they are available. In addition, farmers are dependent on the performance of other consultants whose services can only be as good as the information with which they are provided. Coordination with these suppliers, buyers, and consultants is difficult today, and, other than the use of some rudimentary techniques, are manual in nature and cannot take into account ongoing changing and unplanned-for events.

### SUMMARY

Methods, apparatus, and systems for generating, updating, and executing a crop-harvesting plan are herein discussed. Information regarding crop harvesting may be received from a variety of sources, such as a user, a database, a data feed, a social network, a piece of equipment used to execute a portion of the crop-harvesting plan, and/or a remote sensor via a communication network, such as the Internet, a cloud computing network, a local area network (LAN), a wide area network (WAN), a wireless LAN (WLAN), and/or a computer-implemented social network (e.g., Facebook®, LinkedIn®, Twitter®, etc.). The received information may include, for example, information regarding a planned event, an unplanned event, a contractual requirement, resource utilization, a crop requirement, a harvesting requirement, local knowledge, operational profitability, resource availability, remotely sensed information, information received via a resource, and/or information received via a computer-implemented social network.

The received information may be used to generate, via a crop-harvesting plan generator, one or more crop-harvesting plans. A crop-harvesting plan generator may include a microprocessor and a memory that resides on a common computer-based platform, wherein the microprocessor includes a computer program product to generate a crop-harvesting plan. The memory may include one or more scoring matrices utilized to generate plan scores based upon the received information. The plan scores may be utilized by the plan generator to generate one or more crop-harvesting plans. Crop-harvesting plans may include, for example, a logistics plan that provides logistical options and instructions for the schedule, movement, and use of equipment, supplies, and resources available for the execution of the crop-harvesting plan. It may also include a sequence of fields to be harvested, site-specific harvesting recommendations and instructions, field locations, maps, resources and their responsibilities, equipment to be used and their capacities, buyers, suppliers, supplies required, and activities to be performed. The crop-harvesting plan may include the status of the portion of the crop-harvesting plan that has been already completed, including supplies consumed, supply shortages, the status of the actual crops that have been or are yet to be harvested, capacity utilization, and accomplishments. In one embodiment, a crop-harvesting plan may include measures of plan effectiveness and efficiencies, for example, a utilization index, a crop index, a time index, a cost index, a capacity rating, and recommendations to improve the indexes. In another embodiment, the crop-harvesting plan may include a logistics plan that provides logistical options and instructions for the schedule, movement, and use of equipment, supplies, people and other resources available for the execution of the crop-harvesting plan.

One or more crop-harvesting plans may be evaluated according to one or more criterion. A preferred crop-harvesting plan may then be selected based upon the evaluation. The selected crop-harvesting plan may then be provided to the user via, for example, the communication network. In some cases, a plurality of crop-harvesting plans are selected and provided to the user. In other cases, a portion of a crop-harvesting plan may be provided to a user, an individual employee or other designate of the user, fed directly into the electronic systems of the crop-harvesting equipment, and/or into the electronic devices used by the user or other personnel.'

In some instances, additional information regarding the selected crop-harvesting plan may be received from, for example, the user, the manager, the database, the data feed, the equipment, and/or the remote sensor. The additional information may relate to, for example, field condition, crop condition, weather, market pricing for the crop, equipment availability, insurance claims for crop damage, operating costs or actual progress to that point in executing the plan. The selected crop-harvesting plan may then be dynamically updated based upon the received additional information and the updated crop-harvesting plan may be provided to the user via a communication network.

In one embodiment, the received information may relate to an outcome and a best practice for harvesting the crop may be determined based on that outcome. In another embodiment, a best practice may be received from, for example, a buyer, supplier, social network, or equipment manufacturer. The crop-harvesting plan may then be updated with the determined best practice.

In another embodiment, the crop-harvesting plans may include multiple attributes or categories of information, such as field and crop condition, visually entered and/or remotely sensed, and the field's and crop's availability and readiness upon which to execute the crop-harvesting plan, resources including equipment, personnel, and supplies available to execute the crop-harvesting plan, type of crops to be harvested, transportation, storage, and processing of the crop, local knowledge, planned and unplanned events, weather data, crop pricing data, buyer and contract data, and the like. On some occasions, an attribute of the received information may be determined and the received information may be incorporated into a corresponding attribute of the crop-harvesting plans. For example, when an attribute of the received information relates to a field and/or crop condition, it may be incorporated into a corresponding field and/or crop condition attribute of the crop-harvesting plan.

On some occasions, the received information may include remotely sensed data including data or images produced by a sensor or images of fields and/or crops. The remotely sensed data may be obtained by drones, aircrafts, satellites, and/or physical sensors. The remotely sensed data may be analyzed by, for example, the crop-harvesting plan generator and the condition of crops or fields may be determined therefrom. A sequence of crop-harvesting locations based on the determined condition of the crops as well as other information such as the condition of the fields may then be incorporated into the crop-harvesting plan.

In one embodiment, the potential impact of utilizing a particular resource, sequence, and/or schedule to execute a portion of the crop-harvesting plan may be determined and a recommendation may be provided to, for example, the user based upon the determined potential impact.

In some instances, the received information may include climate data, historical weather data, current weather data, and/or predicted weather data and the crop-harvesting plan may be dynamically updated as current weather data, and predicted weather data is received.

In another embodiment, a set of instructions for execution of a portion of the crop-harvesting plan may be generated and provided to, for example, the user, the manager, the database, the data feed, the remote sensor, and/or a piece of equipment utilized to execute a portion of the crop-harvesting plan via, for example, a device used by the recipient, such as a mobile phone or GPS device. In some instances, the set of instructions may be specific to the user, the manager, the buyer, the supplier, and/or the piece of equipment utilized to execute a portion of the crop-harvesting plan.

In one embodiment, execution of the crop-harvesting plan may be monitored. In some cases, a status for one or more resources utilized to implement the crop-harvesting plan may be determined and an alert may be provided to the user responsively to the determined status when, for example, a resource is being under-utilized or a supply of a resource is lower than a threshold supply. In some instances, an impact of utilizing a resource to execute a portion of the crop-harvesting plan may be determined and a recommendation based upon the determined impact of the utilization may be provided to the user.

Exemplary systems provided herein include a crop-harvesting plan generator and a user interface communicatively coupled to one another via a communication network. The crop-harvesting plan generator may be configured to receive information regarding crop harvesting from, for example, a user, a manager, a data feed, a database, equipment, a social network, and/or a remote sensor. The crop-harvesting plan generator may also be configured to generate a plurality of crop-harvesting plans for harvesting of a crop based upon the received information, evaluate the plurality of crop-harvesting plans according to one or more criterion, select a crop-harvesting plan responsively to the evaluation, and provide the selected crop-harvesting plan to a user interface via a communication network.

The user interface may be configured to receive the selected crop-harvesting plan from the crop-harvesting plan generator via the communication network, provide the selected crop-harvesting plan to the user, receive the information regarding crop harvesting from the user, and provide the received information regarding crop harvesting to the crop-harvesting plan generator. Optionally, the system may further include a database communicatively coupled to the crop-harvesting plan generator that is configured to store the received information regarding crop harvesting, the plurality of crop-harvesting plans, and/or the selected crop-harvesting plan.

### BRIEF DESCRIPTION OF THE DRAWINGS

The present application is illustrated by way of example, and not limitation, in the figures of the accompanying drawings, in which:

FIG. 1 is a block diagram illustrating an exemplary system having elements configured to design a crop-harvesting plan, in accordance with embodiments of the present invention;

FIG. 2 is a block diagram illustrating exemplary crop-harvesting data, in accordance with embodiments of the present invention;

FIG. 3 depicts an exemplary diagram of layered geographic and/or geologic data for an area of land, in accordance with embodiments of the present invention;

FIGS. 4A and 4B illustrate exemplary processes for generating a crop-harvesting plan, in accordance with embodiments of the present invention;

FIG. 5 illustrates an exemplary process for determining a best practice for harvesting a crop, in accordance with embodiments of the present invention;

FIG. 6 illustrates a method of generating and evaluating a crop-harvesting plan, in accordance with embodiments of the present invention.

FIGS. 7-11 illustrate scoring matrices for use in a crop-harvesting plan generator, in accordance with embodiments of the present invention.

FIGS. 12-22B illustrate various exemplary graphic user interfaces (GUI) that may be used to generate and provide a crop-harvesting plan to a user, in accordance with embodiments of the present invention.

Throughout the drawings, the same reference numerals and characters, unless otherwise stated, are used to denote like features, elements, components, or portions of the illustrated embodiments. Moreover, while the subject invention will now be described in detail with reference to the drawings, the description is done in connection with the illustrative embodiments. It is intended that changes and modifications can be made to the described embodiments without departing from the true scope and spirit of the subject invention as defined by the appended claims.

### DETAILED DESCRIPTION

The present invention integrates various types of data from various sources to generate a crop-harvesting plan that may be used to dynamically aid farmers and other production agriculture professionals when determining, updating, and executing a crop-harvesting plan. Crop-harvesting plans may include a variety of recommended harvesting practices and projected outcomes resulting from the implementation of the recommended harvesting practices. In some embodiments, a user may be able to manipulate various aspects of a crop-harvesting plan in order to hypothetically predict outcomes for implementation of various harvesting practices. In this way, a user can anticipate what a cost or impact of implementation of a particular harvesting practice may result in prior to its implementation in the “real world.” This may help the user predict and manage bottlenecks, constraints, costs, and risks associated with various crop-harvesting strategies and practices. A crop harvesting process may be defined as the process by which a crop is removed from the field and all of the associated activities related to that process, such as transporting, processing, and marketing of a crop.

In some cases, a crop-harvesting plan may be designed to include the user's local knowledge or requirements. For example, a crop-harvesting plan may be designed to incorporate information which is only known at the local level such as the availability or unavailability of a resource, a user-defined preference (e.g., always start on field X), a contractual obligation such as a landlord deadline for completing all or part of the crop-harvesting, or a contractual obligation such as a buyer deadline and instructions for the delivery of the harvested crop.

In one embodiment, a crop-harvesting plan may be broken down or divided into one or more plans that include instructions for executing a portion of the crop-harvesting plan. On some occasions, a plan may be customized for execution by a particular manager, employee, or group of employees that assist a user in the execution of the crop-harvesting plan.

In one embodiment the crop-harvesting plan may include a logistics plan that provides logistical options and instructions for the schedule, movement, and use of equipment, supplies, and resources available for the execution of the crop-harvesting plan.

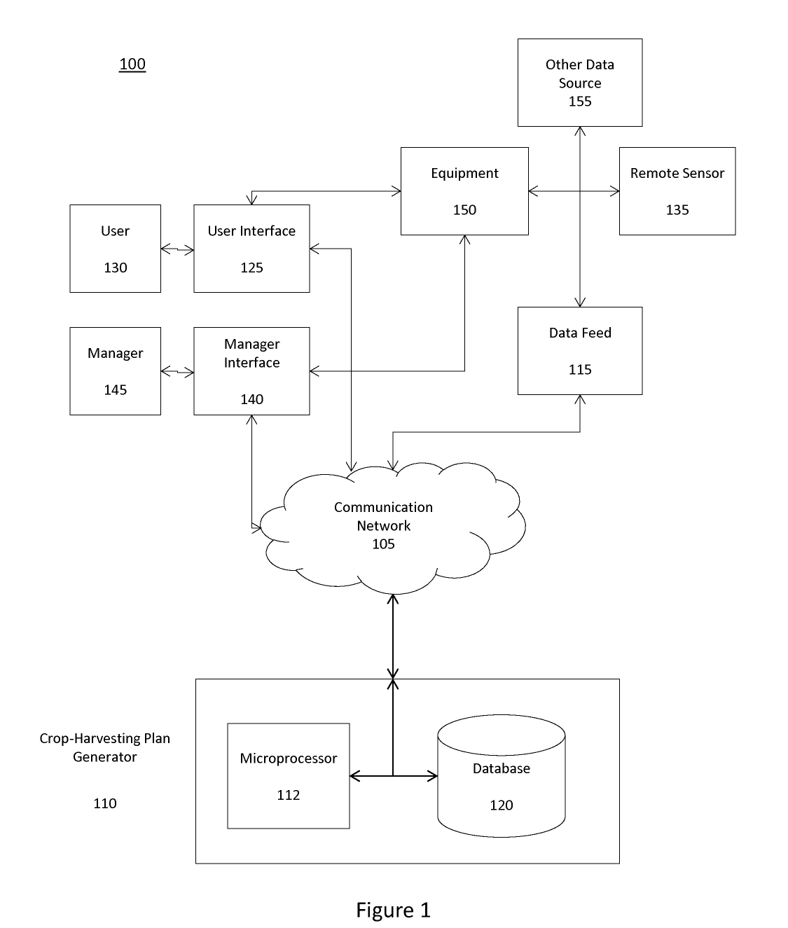

Turning now to FIG. 1, a block diagram depicting an exemplary system 100 for executing one or more of the processes described herein is illustrated. System 100 includes a communication network 105, a crop-harvesting plan generator 110, a data feed 115, a database 120, a user interface 125, a user 130, a remote sensor 135, a manager interface 140, a manager 145, one or more pieces of equipment used to execute the plan 150, and other data sources 155. Note, in some instances some of these components may be absent from instantiations of the present invention. For example, once crop-harvesting plans have been generated and deployed, user 130 (e.g., a farmer, manager, or other person or entity involved in the harvesting of a crop) need not be present. Likewise, users 130 may download crop-harvesting plans to personal computers, tablet computers, phones, or other portable electronic devices, in which case the crop-harvesting plan information may be self-contained and access to the communications network and other elements of system 100 may not be required until the crop-harvesting plan or information concerning crop-harvesting activities needs to be modified or updated. Thus, system 100 in FIG. 1 is best regarded merely as an example of a system in which the present invention finds application.

As shown, communication network 105 communicatively couples the other elements of system 100 to one another. Exemplary communication networks 105 include cloud computing networks, the Internet, local area networks (LAN), wireless local area networks (WLAN), and wide area networks (WAN). Usually, though not necessarily, user 130 may connect to system 100 periodically, either to upload crop-harvesting information (e.g., crop-harvesting plan modifications and additions, instructions, accomplishments, outcomes, or unplanned events), download new or updated crop-harvesting plans, and so on. In some embodiments, multiple users 130 may be enabled to communicate with one another via communication network 105 in a manner similar to, for example, a social network and/or social networking information may be used to generate the crop-harvesting plan.

In some embodiments, crop-harvesting plan generator 110 includes a microprocessor 112 and a database 120 that resides on a common computer-based platform, including one or more servers running the main application, a database server, and a number of operator terminals such as the user interface 125 and manager interface 140. The servers may be a physical server or a virtual machine executing on another hardware platform. The microprocessor 112 receives and provides data for a particular crop-harvesting plan to and from the database 120. The microprocessor 112 includes a computer program product embodied on a computer readable medium. The microprocessor 112 is configured to execute the computer program product to generate a crop-harvesting plan or multiple crop-harvesting plans. The crop-harvesting plan generator 110 may include network hardware and software to control communications equipment. In a simple setup the crop-harvesting plan generator 110 may run on a single server. In a more advanced setup, the infrastructure may contain several servers, networking hardware and operator terminals. Crop-harvesting plan generator 110 generates a crop-harvesting plan by receiving inputs via the communication network 105 from user 130, manager 145, equipment 150, other data 155, remote sensors 135, data feed 115, and accessing data stored in database 120. The microprocessor 112 accesses these inputs and executes the embedded computer program to determine crop-harvesting plan data.

On some occasions, the components of system 100 may communicate directly or indirectly with crop-harvesting plan generator 110 and/or database 120 via communication network 105. Additionally, user 130, manager 145, equipment 150, other data sources 155, and remote sensor 135 may communicate with crop-harvesting plan generator 110, microprocessor 112, and/or database 120 via a communicative coupling to data feed 115 which is coupled to crop-harvesting plan generator 110, microprocessor 112, and/or database 120. Data feed 115 may provide data to the crop-harvesting plan generator 110 relating to, for example, crop characteristics, weather, climate, geological data and events (e.g., thunderstorms, frosts), cost of supplies, costs, and remotely sensed data. Data feed 115 may be provided by, for example, various public or private sources including free (e.g., US Department of Agriculture or National Oceanic and Atmospheric Administration) and/or fee based entities (e.g., Chicago Board of Trade). On some occasions, data feed 115 may be associated with a system used by a supplier and/or buyer. In some embodiments, data feed 115 may be associated with a social network (e.g., Twitter®, Facebook®, LinkedIn®). In this way, one or more users or other suppliers of data may communicate information between one another that may be relevant to a crop-harvesting plan.

Exemplary remote sensors 135 that may provide data to crop-harvesting plan generator 110 include drones, aircrafts, satellites, and/or physical sensors to measure, for example, moisture levels, crop conditions, and field conditions for one or more fields. In some embodiments, remote sensors 135 may include remotely controlled drones, manned or unmanned aircrafts, or vehicles that remotely sense or gather crop-harvesting information, such as field condition.

Particularly, drones may include a rotary unmanned aircraft system (UAS) that typically has between two to ten rotors. These rotors provide optimal stability, control and maneuverability for obtaining maximum detail regarding crop and field conditions. However, a rotary UAS has limited battery efficiency and is therefore best utilized for relatively smaller fields (e.g., less than 100 acres). Drones may also include a fixed-wing UAS. A fixed-wing UAS operates like a small model airplane and may be fabricated using lightweight foam. Because of its minimal weight, a fixed-wing UAS is more efficient in battery usage and is therefore best utilized for larger fields (e.g., over 100 acres) and faster speeds. Both a rotary and fixed-wing UAS may be used for measuring crop conditions, crop damage for insurance purposes, harvest timing, and drainage issues for the crop-harvesting plan. Further information obtained from a UAS that may be incorporated into the crop-harvesting plan include plant emergence, plant populations, nitrogen deficiencies, plant health assessments, disease symptoms, insect damage, moisture stresses, the impact of tillage and crop rotations, corn senescence for specific hybrids, the impact of soil salinity, weather damage (e.g., downed corn), and a comparison of hybrids for maximum yields. The crop-harvesting plan generator 110 may be in communication with one database 120 or a series of databases linked together.

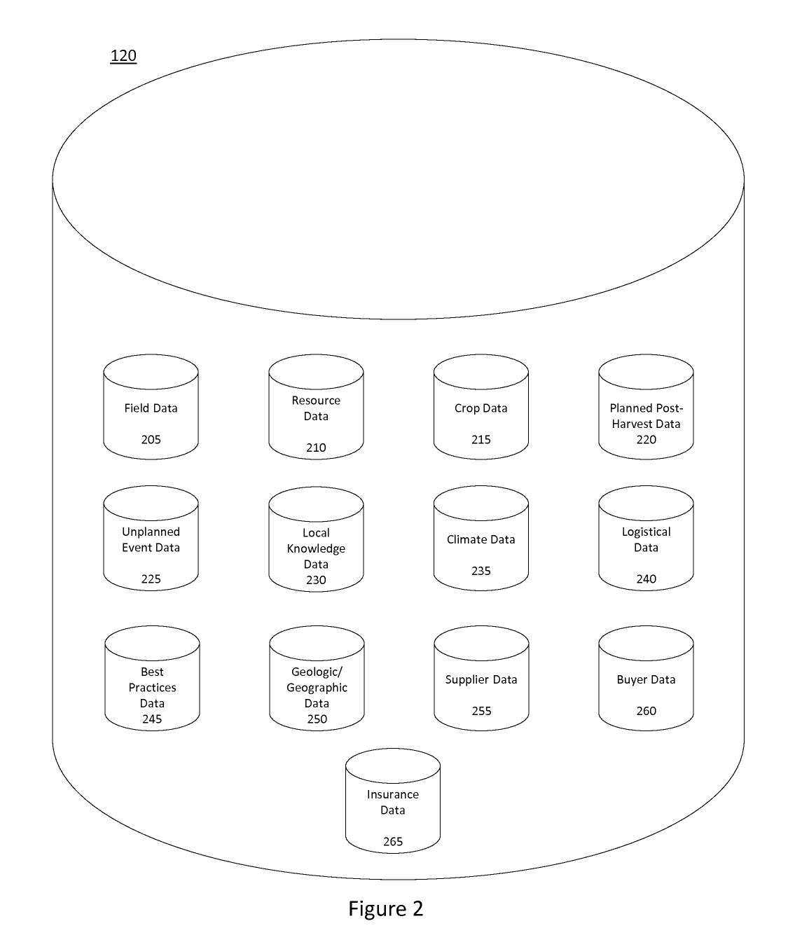

The database 120 may be embodied on a memory device, such as, but not limited to, a hard disk drive. The database 120 may be provided to the memory device from a storage device, such as, but not limited to a computer disk or a download via the communication network 105. In another embodiment, the database 120 may be manually input into the microprocessor 112. Database 120 may store data related to any facet of the crop-harvesting process including, for example, field availability and condition, crop availability and condition, resource availability or utilization, crop characteristics (e.g., a crop's ability to withstand wind, resist disease, tolerate frost, and/or other characteristics), unplanned events (e.g., inclement weather, equipment breakdowns, illness and other personnel issues, and changing market prices), local knowledge (e.g., user preferences, user contractual obligations, and historical outcomes), and planned crop-harvesting events (e.g., personnel availability, tiling, tillage, and fertilizer or other processes to prepare a field for the next crop). Further details regarding the information stored in database 120 are discussed below with regard to FIG. 2.

The crop-harvesting plan generator 115, via the user interface, allows the user 130 to manually select or enter, for example, various preferences (e.g., starting date, targeted end date, starting locations), contracted, legal, and other landlord requirements, end use considerations for a crop, including delivery instructions and locations, contracted, legal, and other buyer requirements, including delivery instructions and locations, field data (e.g., visually determined conditions, features, entry points), equipment type and conditions, transportation and relocation considerations (e.g., weight constraints), employee considerations, and/or crop-harvesting local knowledge that may be incorporated into a crop-harvesting plan. On some occasions, manually selected preferences and other user entered information may be stored in database 120.

In some embodiments, a user may enter local knowledge (e.g., preferences) or requirements into crop-harvesting plan generator 115 for incorporation into a crop-harvesting plan. For example, a user may enter a period of time in which a particular resource is available or details of a required supply including its delivery and these entries may be incorporated into the crop-harvesting plan by crop-harvesting plan generator 110. Alternatively, crop-harvesting plans may be generated in a partially or wholly automated manner by crop-harvesting plan generator 110 analyzing, for example, historical, real-time, or known data relating to crop-harvesting. For example, crop-harvesting plan generator 110 may automatically include historically known climate conditions (e.g., average temperature or rainfall) for a field or geographic location during a harvesting season into the generation of a crop-harvesting plan. Of course, many other forms of crop-harvesting plans can be generated including any type of data related to agriculture or crop-harvesting.

Once the crop-harvesting plan is generated, crop-harvesting plan generator 110 provides information about the crop-harvesting plan to user 130. This may be done in a variety of ways, including through the use of an e-mail and/or a message relayed via a messaging system accessible through communication network 105 that includes hyperlinks to a portal at which details regarding the crop-harvesting plan are available. Other forms of communication, such as an instant message or a text message sent via short message service (SMS) to a user's or operator's mobile phone, or an automated phone call placed by the crop-harvesting plan generator 110, may also be used to, for example, indicate a crop-harvesting plan has been updated or an unplanned event has occurred. In FIG. 1, user interface 125 is meant to represent any device via which user 130 can be provided with information regarding the crop-harvesting plan. Exemplary interfaces 125 include computer systems, equipment interfaces as may be provided by, for example, a tractor, combine, and/or other types of harvesting equipment, mobile computing devices (including but not limited to so-called “smart phones”), televisions, tablet computing devices, and portable computing devices.

One or more components of system 100 may include a set of instructions stored on tangible and non-transitory computer readable media. The set of instructions may be executed by one or more components of system 100 to perform one or more of the processes described herein. The non-transitory machine-readable storage medium may include a single medium or multiple media (e.g., a centralized or distributed database or data source and/or associated caches and servers) and may include, for example, solid-state memories, optical media, and/or magnetic media.'

In some embodiments, one or more managers 145 may be enabled to access a crop-harvesting plan via manager interface 140 communicatively coupled to network 105. Manager interface 140 may be similar to user interface 125 and, on some occasions, may be resident on a piece of equipment 150 used to execute the crop harvesting process. Managers 145 may manage and monitor the activities of any number of employees and/or pieces of equipment and the deployment of resources in the harvesting of a crop or executing a crop-harvesting plan. Exemplary managers 145 include employees, managers, owners, equipment operators, suppliers, buyers, consultants, and others who assist user 130 in the harvesting of a crop or in the completing, updating and/or executing a crop-harvesting plan.

Crop-harvesting plan generator 110 may use historical crop-harvesting information in order to, for example, determine the length of a growing season before crops are to be harvested, a period or number of growing degree days (GDDs) required for the crops to mature and be harvest-ready. These determinations may be used to create the crop-harvesting plan, including making product recommendations as well as predictions for outcomes.

In some embodiments, one or more pieces of equipment 150 will serve multiple functions, including for example, as an input device for the user 130 or the manager 145 for them to modify plans, as an output device for the system to control the activity of the equipment according to the crop-harvesting plan generator's 110 instructions, for example steering the equipment, and as a status device reporting progress, activities, and outcomes.

In some embodiments, one or more pieces of equipment 150 may be directly and/or indirectly connected to various components of system 100, such as network 105, database 120, remote sensor 135, data feed 115, manager 145, user 130, and/or crop-harvesting plan generator 110. Exemplary equipment 150 includes vehicles, combines, irrigation equipment, tractors, and other crop-harvesting devices. On some occasions, equipment 150 may be enabled to provide data such as location, times, and dates of usage, capacity, fuel needs, and amount of harvested crop to, for example, database 120 and/or crop-harvesting plan generator 110. In some instances, equipment 150 may be enabled to receive a portion of a crop-harvesting plan and/or other instructions from, for example, user 130, manager 145, and/or crop-harvesting plan generator 110. For example, equipment 150 may receive instructions enabling or instructing the remote operation of equipment 150. In some embodiments, equipment 150 may include a GUI via which an operator, such as user 130 and/or manager 145 may interact with equipment 150 and/or a component of system 100 coupled to equipment 150.

In other embodiments, one or more other data sources 155 may be directly and/or indirectly connected to various components of system 100, such as network 105, database 120, remote sensor 135, data feed 115, manager 145, user 130, and/or crop-harvesting plan generator 110. Exemplary other data sources include websites, buyers, suppliers, and other individuals or organizations that may be involved in one or more phases of a crop-harvesting process.

FIG. 2 is a block diagram depicting exemplary sets of data or databases that may be included in database 120. For example, database 120 may include field data 205, resource data 210, crop data 215, planned events data 220, unplanned events data 225, local knowledge data 230, climate data 235, logistical data 240, best practices data 245, geologic/geographic data 250, supplier data 255, and/or buyer data 260. Information stored in database 120 may be received from, for example, a user, such as user 130, a data feed, such as data feed 115, a manager, such as manager 145, a piece of equipment, such as equipment 150, and/or a remote sensor, such as remote sensor 135 via a communication network, such as communication network 105.

Field data 205 may store information regarding, for example, field locations, the shape of the field, the proximity of fields to each other, the proximity of fields to relevant locations, a user's practices regarding a field (e.g., tillage or crop-planting methods), and field characteristics, such as topographical information, soil type, organic matter, yield capacity, moisture capacity, pH, and fertility. In addition, field data 205 may include historical experiences, observations, and outcomes for a field.

Resource data 210 may store information regarding, for example, resources available for harvesting crops. Exemplary resource data may include equipment data (capacities, costs, fuel consumption), personnel data (skills, availability, wages and benefits), vehicle data (capacities, costs, fuel consumption), location (via GPS), recommended destination routes (for efficient use of time, equipment, and fuel), and storage data (capacities, locations). Resource data 210 may also allow user 130 to submit a request (i.e., for equipment, personnel, vehicles, storage, resources, and/or transportation) via the user interface 125, which is routed to crowd-sourced providers via the communication network 105.

Crop data 215 may store information regarding seed and crop characteristics, including, but not limited to crop planting specifics, crop growing season, crop condition, crop moisture, crop maturity, planned end use of a crop, and disease or pest vulnerabilities for a type of crop.

Crop maturity status may be determined, for example, using the crop moisture levels. These crop moisture levels may be obtained using, for example, image data obtained by remote sensors 135. The moisture levels may be determined from the image data using remote sensors 135, plan generator 110, or any other device capable of determining moisture levels from image data.

Planned event data 220 may store information regarding planned events preceding, during, and/or following completion of a crop-harvesting process. Exemplary planned events may relate to activities such as fertilizer or insecticide application and field preparation for the next crop. Other planned events relate to planned downtime for equipment, planned time-off for personnel, and other events that can be anticipated and planned for.

Unplanned events data 225 may store information relating to unplanned or dynamically changing events that may affect the harvesting of a crop, such as weather or geologic information provided by personal, local and national weather stations, equipment breakdowns or unavailability, unplanned cost changes, personnel issues, supplier and supplies issues, changing availability of supplies, buyer issues, and changing market values for crops. Other unplanned events are events that cannot be anticipated at the time of the creation of the crop-harvesting plan and occur during the execution of the crop-harvesting plan and impact outcomes and activities.

Local knowledge data 230 may store information relating to knowledge or preferences specific to a user and may include, for example, preferred farming practices, preferred field-harvesting sequences, preferred scheduling, field or site-specific knowledge, and past experience. On some occasions, local knowledge data 230 may be used to override or modify an aspect of a crop-harvesting plan in a manner similar to application of a rule to the crop-harvesting plan generation process. On some occasions, local knowledge data 230 may include data received via a social network. On other occasions, contractual requirements, special supplier delivery instructions, special buyer requirements, or special landlord requirements, for example the crop must be harvested by a specific date and delivered to a specific location.

Climate data 235 may store information relating to weather and/or climate for a particular region or field.

Logistical data 240 may store information relating to the logistics of executing a crop-harvesting plan, such as movement of people, equipment, supplies to and from the field, including field to field, supplier to field, field to buyer, and field to storage, including routes, schedules, and special instructions.

Best practices data 245 may store information relating to known or determined best practices for harvesting a crop. Best practices data may be determined from analysis of, for example, local crop-harvesting processes, crop-harvesting plans, actual crop-harvesting outcomes, recommendations of, for example, governmental agencies or distributors of supplies or equipment and/or a comparison of expected crop-harvesting yields and actual crop-harvesting outcomes. On some occasions, best practices data 245 may include data received via a social network.

Geographic/geologic data 250 may include geographic and/or geologic data related to, for example, fields upon which crops are harvested and grown, and roads to move supplies, equipment, and people. Exemplary geographic or geologic data may include roadway, surface and/or underground water, and landmark locations. Geographic/geologic data 250 may be derived from a variety of sources, such as satellite images, global positioning information, historical information regarding an area of land, plat book service providers, NGOs, and public and private organizations and agencies.

Supplier data 255 may include supplies data (SKUs, quantities, locations, prices) and supplier data (names, locations, services, contractual information), as well as delivery and/or application instructions, dates, and terms.

Buyer data 260 may include buyer data (names, locations), as well as contractual information such as delivery instructions, dates, prices, and other terms.

Insurance data 265 may include information on policies with the Federal Crop Insurance Program, Crop-Hail policies provided by private insurers, and Multiple Peril Crop Insurance covering all types of natural causes including drought, excessive moisture, freeze and disease, including yield and price protection against potential losses in revenue, in view of real-time data provided by remote sensor 135.

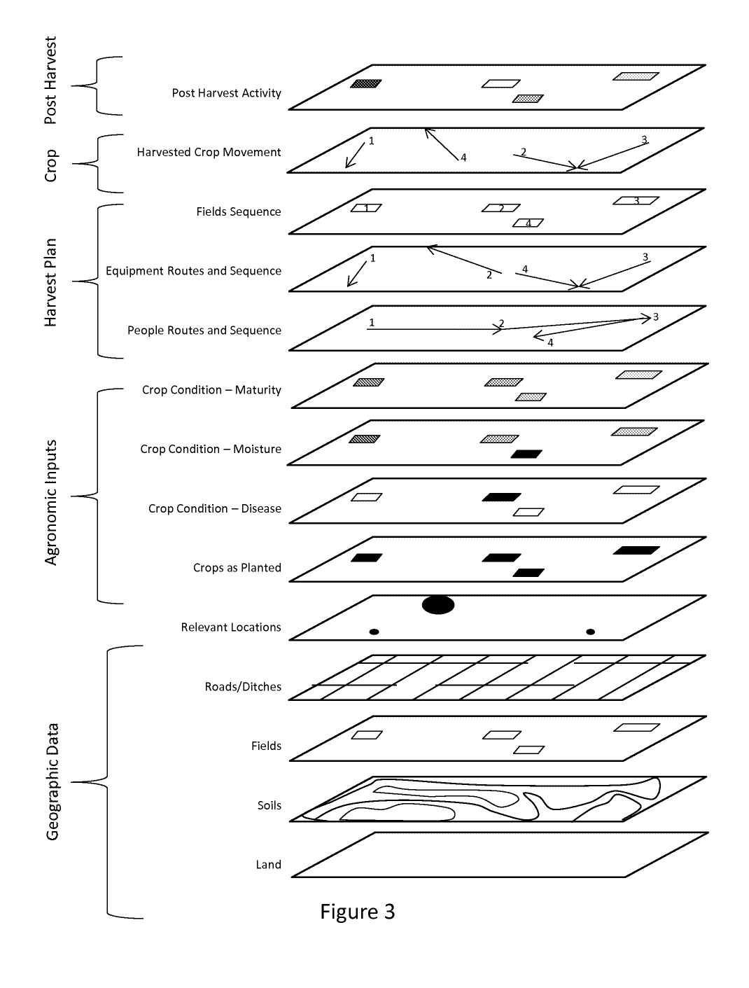

On some occasions, the geographic/geologic data 250 may be part of a geographic information system (GIS), an example of which is provided in FIG. 3. As shown, a GIS includes various data structures, each of which may be regarded as a layer. Different layers provide information regarding various aspects of a region, for example, various layers of the GIS may relate to geographic, agronomic, harvest plan, crop, and post-harvesting data. Exemplary geographic data may include, for example, information related to an area of land (e.g., size, location, etc.), soil attributes (e.g., soil types, texture, organic matter, fertility, etc.), fields upon the land (e.g., size, shape, location, etc.), any man-made features upon the land (e.g., buildings, roads, ditches, etc.), and relevant locations upon the land of various features (e.g., rock piles, silos, water sources, etc.). Exemplary agronomic data may include, for example, information related to crops as planted (e.g., crop type, location, etc.) and crop condition (e.g., the presence of disease, levels of moisture, and/or crop maturity). Exemplary harvest plan data may include, for example, information related to a sequence for harvesting fields, routes for the movement of people, harvested crops, and/or equipment and a sequence and schedule for the movement of people and/or equipment along the routes. Exemplary crop data may include, for example, information related to routes, schedules, and sequences for moving harvested crops to various locations. Exemplary post-harvest data may include, for example, information related to operations performed on the land following a harvest (e.g., tilling, fertilizing, etc.). On some occasions, crop data and/or post harvest data may be received from resources (e.g., equipment and/or employees) performing harvesting activities.

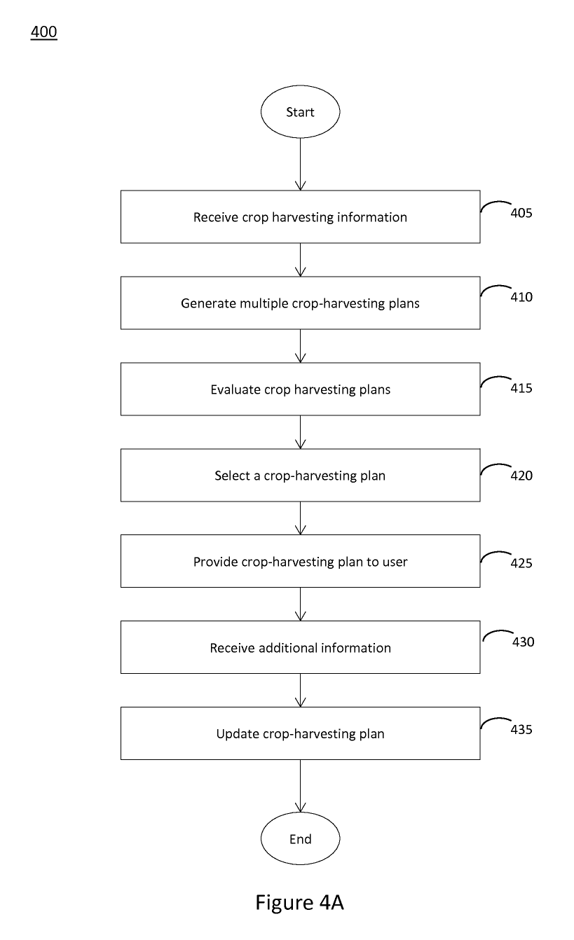

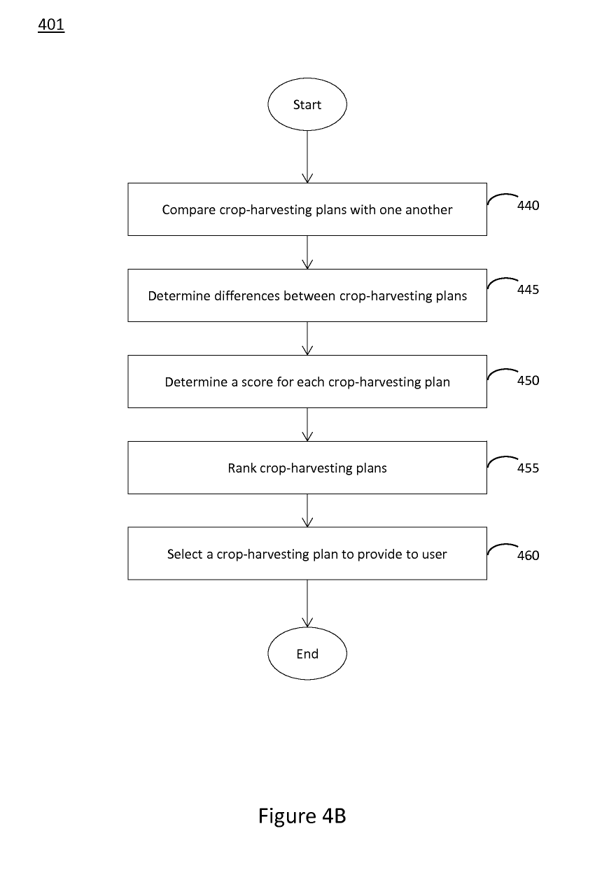

FIG. 4A is a flow chart depicting an exemplary process 400 for generating a crop-harvesting plan. Process 400 may be executed by, for example, any of the systems and/or system components disclosed herein.

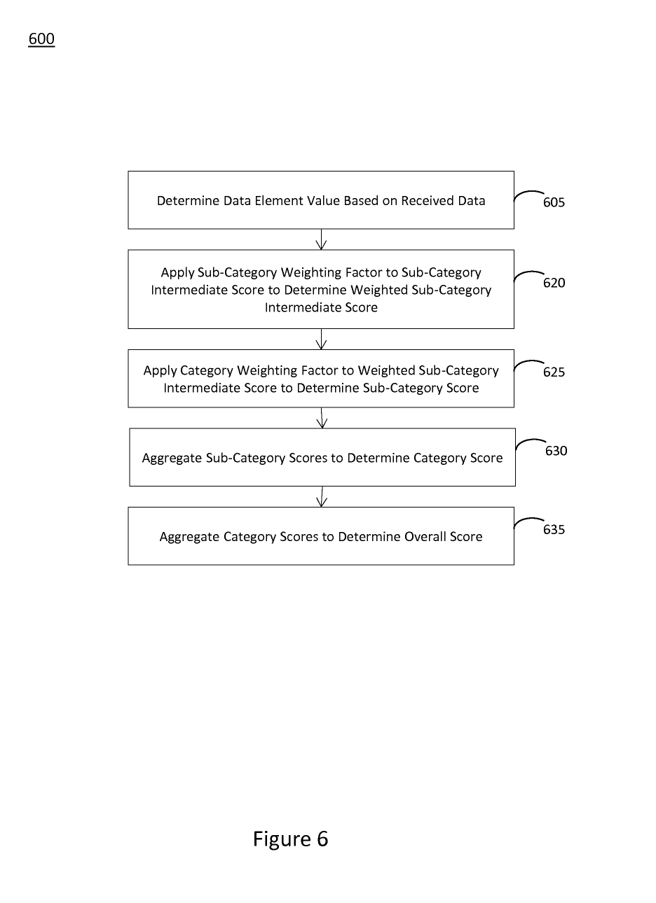

In step 405, information regarding crop-harvesting may be received by, for example, a crop-harvesting plan generator, such as crop-harvesting plan generator 110 from, for example, a user, such as user 130, a database, such as database 120, a data feed, such as data feed 115, a manager, such as manager 145, equipment, such as equipment 150, and/or a remote sensor, such as remote sensor 135 via a communication network, such as communication network 105 and/or an interface, such as interfaces 125 or 140. Exemplary received information may relate to fields or resources for harvesting crops, crop characteristics, planned events, unplanned events, local knowledge, weather or climate, logistics, crop growing season, the date the crop is planted, crop-harvesting best practices, human resources considerations, and/or geologic/geographic characteristics of fields or land on which the crop is to be harvested. On some occasions, the received information may include one or more previously generated crop-harvesting plans and/or a best practice associated with an aspect of the crop-harvesting plan. In some embodiments, a user may provide information regarding crop-harvesting to the crop-harvesting generator via a GUI, an example of which is depicted in the screenshot of FIG. 6.

One or more crop-harvesting plans may then be generated based upon the received information (step 410). When two or more crop-harvesting plans are generated, each of the crop-harvesting plans may be evaluated according to one or more criterion (step 415). Exemplary criterion include overall plan efficiency, utilization of resources, financial and/or temporal costs, risks, potential profit margins for the harvested crops, and logistical considerations, including potential bottlenecks and constraints. Then, in step 420, a crop-harvesting plan may be selected based upon the evaluation and provided to the user via, for example, a communication network (step 425). On some occasions, one or more of the generated crop-harvesting plans may be provided to the user and, in some instances, the user may select one or more of the crop-harvesting plans.

In some embodiments, additional information may be received following step 425 (step 430) and the crop-harvesting plan may be updated to incorporate the additional information (step 435). For example, in step 430, information regarding a weather event, equipment breakdown, unavailable personnel, supplier issue, or other conditions may be received and, in step 435, the crop-harvesting plan may be updated accordingly. The updated plan may then be provided to the user. Following step 435, process 400 may end.

FIG. 4B is a flow chart depicting an exemplary process 401 for evaluating a crop-harvesting plan as described above with regard to step 415. Process 401 may be executed by, for example, any of the systems and/or system components disclosed herein.

In step 440, one crop-harvesting plan can be compared to benchmarks and/or two or more crop-harvesting plans may be compared with one another and/or compared to benchmarks. In some embodiments, this comparison may include a comparison of corresponding attributes of the two or more crop-harvesting plans. Differences between the crop-harvesting plans and/or attributes included therein may then be determined based on the comparison (step 445) and a score for each crop-harvesting plan may be calculated (step 450). In some cases, the score may be an overall score for a crop-harvesting plan while in other cases sub-scores related to a particular criterion or group of criterions may be determined. The crop-harvesting plans may then be ranked according to their overall score and/or sub-scores (step 455). One or more crop-harvesting plans may then be selected for presentation to a user based upon their relative scores or sub-scores (step 460). Following step 460, process 401 may end.

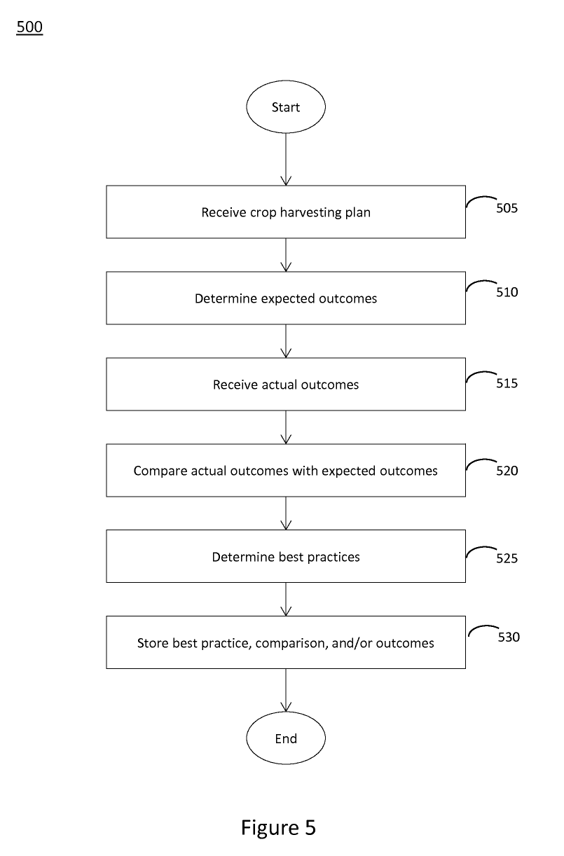

FIG. 5 is a flow chart depicting an exemplary process 500 for determining a best practice for harvesting a crop. Process 500 may be executed by, for example, any of the systems and/or system components disclosed herein.

In step 505, a crop-harvesting plan may be received and expected results or outcomes for the crop-harvesting plan may be determined (step 510). In step 515, information regarding the completed crop-harvesting plan, such as yield, costs, and efficiencies may be received and compared with the expected results and outcomes for the crop-harvesting plan (step 520). A best practice may be determined based upon the comparison (step 525) and results of the comparison and/or the determined best practice may be stored in, for example, database 120 (step 530). Following step 530, process 500 may end.

FIG. 6 is a flow diagram illustrating a method 600 of implementing steps 410 and/or 415 as shown in FIG. 4A. At step 605, crop-harvesting plan generator 110 can determine a data element value corresponding to received data for the field. For instance, crop-harvesting plan generator 110 can access configuration data (e.g., stored in database 120) to determine a data element value associated with the data element, as is further described herein.

The received data for the field can include one or more categories. Examples of categories can include, but are not limited to, crop quality, crop readiness, and field details. At least one of the categories can include one or more sub-categories. For instance, a crop quality data category can include sub-categories such as GDDs, seed selection (percentage of matched seed to soil types), diseases, pests, field damage (percentage of damaged crop), or other sub-categories.

At step 620, crop-harvesting plan generator 110 can apply a sub-category weighting factor to the sub-category intermediate score to determine a weighted sub-category intermediate score. At step 625, crop-harvesting plan generator 110 can apply a category weighting factor to the weighted sub-category intermediate score to determine a sub-category score. At step 630, crop-harvesting plan generator 110 can aggregate sub-category scores to determine a category score. At step 635, crop-harvesting plan generator 110 can aggregate category scores to determine an overall score. Crop-harvesting plan generator 110 can determine the overall score with respect to an entire field, a portion of the field, or both.

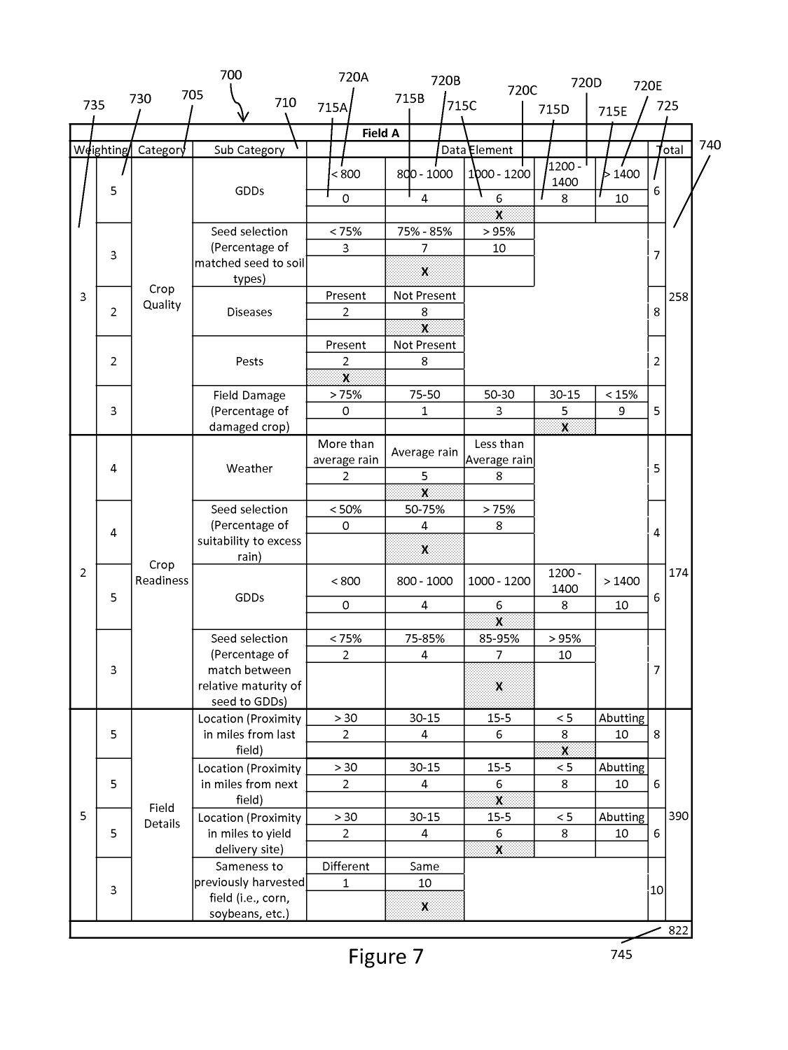

FIG. 7 illustrates a table 700 that represents an example scoring matrix for use in a method of determining a field score, in accordance with one or more aspects of this disclosure. As illustrated in FIG. 7, table 700 can include category 705 of received data for a field. However, while illustrated with respect to three categories, in certain examples, table 700 can include a single or a plurality of categories. In the illustrated example, categories 705 correspond to crop quality, crop readiness, and field details.

As further illustrated in FIG. 7, category 705 can include sub-categories 710, and under the category of crop quality, these sub-categories 710 may include GDDs, seed selection (percentage of matched seed to soil types), diseases, pests, and field damage (percentage of damaged crop). In certain examples, sub-categories 710 can include more or fewer sub-categories. In general, sub-categories 710 can include any number of sub-categories (e.g., zero, one, two, five, fifty, or other numbers of sub-categories) that are deemed relevant to a category of data.

Crop-harvesting plan generator 110 can classify received data for the field according to a sub-category and/or category. Received data can take the form of a data element, such as data elements 715A-715E. Data elements 715A-715E are the assigned number value given to the received data if the received data corresponds to a particular threshold characteristic 720A-720E. In FIG. 7, if the received data corresponds to a particular characteristic 720A-720E, it is illustrated with an “X” below the corresponding data elements 715A-715E. The value of the data element 715A-715E that corresponds to the selected threshold characteristic is depicted in the sub-category sub score 725.

Crop-harvesting plan generator 110 can apply a sub-category weighting factor, such as sub-category weighting factor 730 to determine a sub-category intermediate score. For instance Crop-harvesting plan generator 110 can multiply sub-category weighting factor 730 by the determined sub-category sub-score 725 (e.g., “6” in this example) to determine a sub-category intermediate score (e.g., “30” in this example). Crop-harvesting plan generator 110 can add together each of the sub-category intermediate scores, and apply (e.g., multiply) a category weighting factor, such as category weighting factor 735, to the determined sub-category intermediate score to determine a category score 740 for the category 705. In some examples, Crop-harvesting plan generator 110 can aggregate a plurality of determined category scores to determine an overall score 745. For instance, Crop-harvesting plan generator 110 can determine an overall score for the field as the sum of a plurality of determined category scores.

Each of the above-described weighting factors (i.e., sub-category weighting factors and category weighting factors) can be different or the same. In addition, each of the weighting factors can be modified, such as automatically by crop-harvesting plan generator 110 and/or in response to input received from one or more of user interfaces 125 or manager interfaces 140. For instance, a user 130 can modify one or more of the weighting factors, such as by providing user input via one or more of user interfaces 125 to adjust a weighting factor and/or provide a new value for the weighting factor.

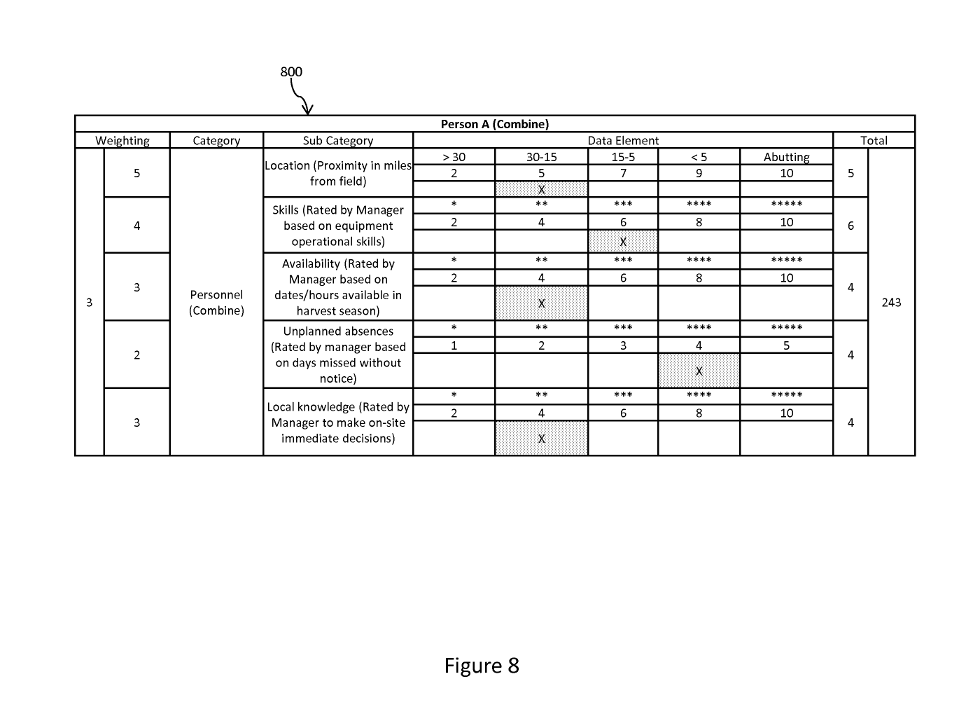

FIG. 8 illustrates table 800 that represents an example scoring matrix for use in a method of determining a crop-harvesting logistics plan, in accordance with one or more aspects of this disclosure. Specifically, FIG. 8 illustrates table 800 that represents an example scoring matrix with respect to different (i.e., as compared to table 700 of FIG. 7) categories and sub-categories of data. As illustrated in FIG. 8, crop-harvesting plan generator 110 can receive data for a category of a person who can operate a combine. The personnel (combine) category can include a plurality of sub-categories, such as sub-categories corresponding to location (proximity in miles from field), skills (rated by manager based on equipment operational skills), availability (rated by manager based on dates/hours available in harvest season), unplanned absences (rated by manager based on days missed without notice), and local knowledge (rated by manager to make on-site immediate decisions). As illustrated, crop-harvesting plan generator 110 can aggregate the one or more data element scores within a sub-category to determine a sub-category sub-score. Crop-harvesting plan generator 110 can apply a sub-category weighting factor to the sub-category sub-score to determine a sub-category intermediate score, and can apply a category weighting factor to the sub-category intermediate score to determine a category score. In this example, the category score is the overall score for Person A (Combine).

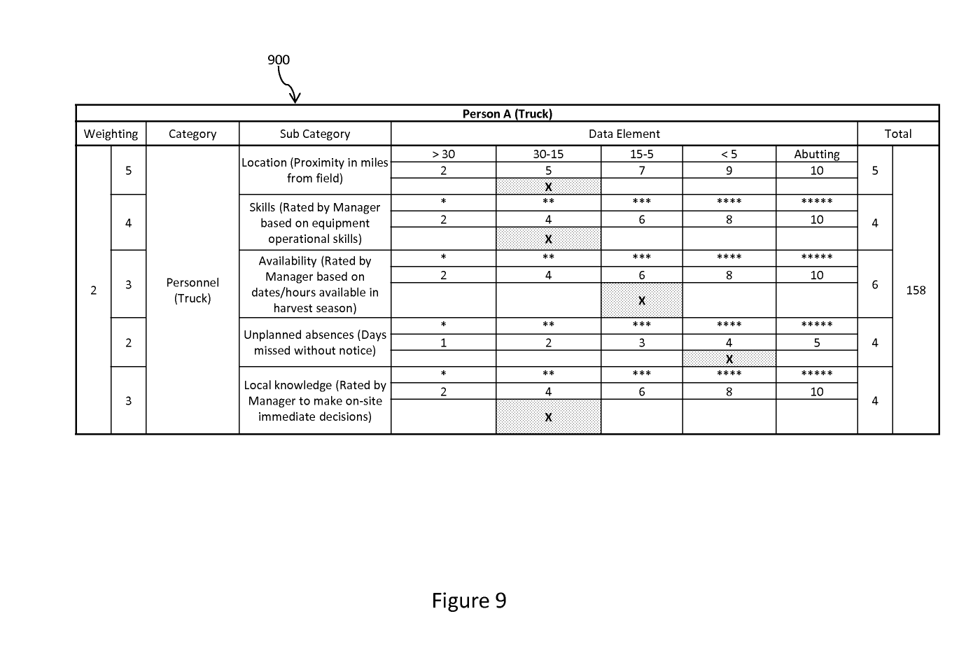

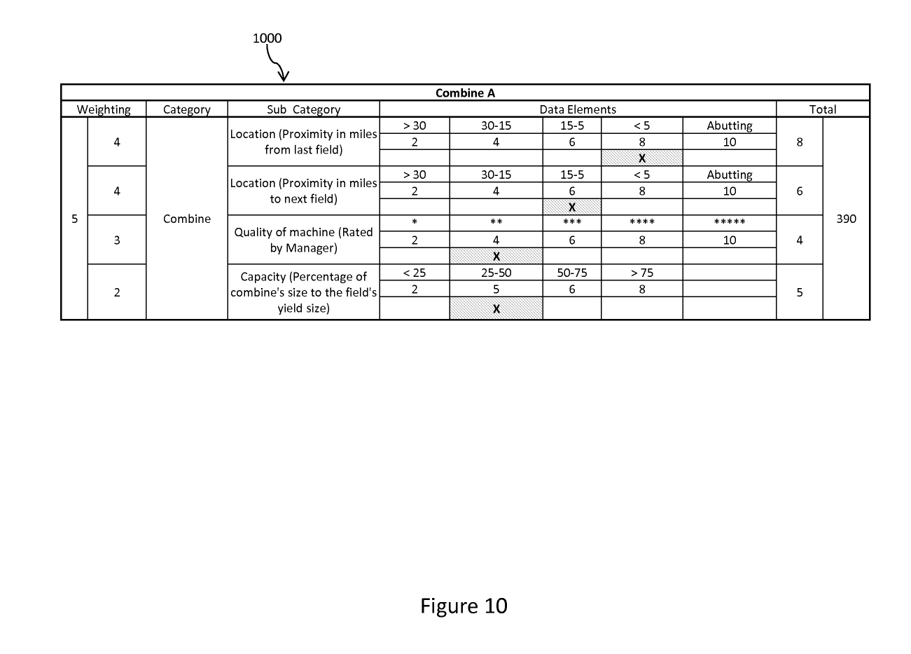

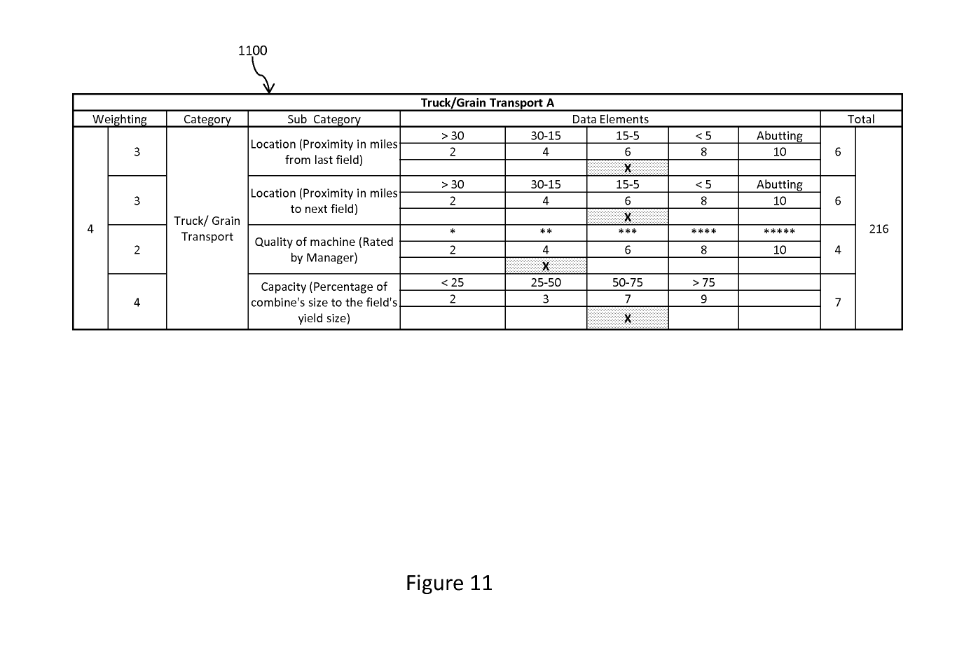

FIGS. 9-11 illustrate tables 900, 1000 and 1100 that represent additional example scoring matrices with respect to different resources (e.g., personnel driving the grain transport vehicle(s), combine(s), and grain transport vehicle(s). As such, they have different (i.e., as compared to tables 700 and 800 of FIGS. 7 and 8 respectively) categories and sub-categories of data, but are utilized in a similar manner to that of tables 700 and 800.

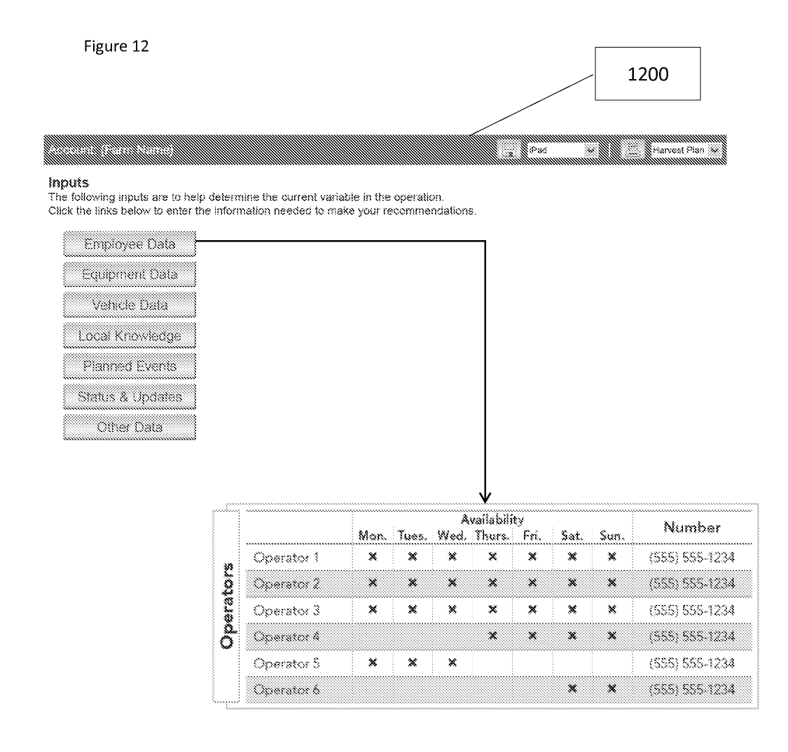

FIGS. 12-22B illustrate various exemplary graphic user interfaces (GUI) that may be used to gather information regarding crop-harvesting and/or generate and provide a crop-harvesting plan to a user and/or manager, such as user 130 and/or manager 145. The GUIs of FIGS. 12-22B may be prepared by, for example, crop-harvesting plan generator 110 and provided to a user, such as user 130 via an interface, such as user interface 125.

FIG. 12 illustrates an exemplary introduction GUI 1200 via which a user may input information to be incorporated into a crop-harvesting plan. For example, GUI 600 enables a user to input, view, and/or modify information regarding employee data, equipment data, vehicle data, local knowledge, planned events, status and updates, and other data, such as that related to buyers and suppliers/supplies. On some occasions, selection of one or more menu items may initiate the display of an interface by which a user may enter harvesting information. Exemplary interfaces may include a series of questions and text entry boxes into which a user may enter information, or the capability of inputting data through the user interface by another method.

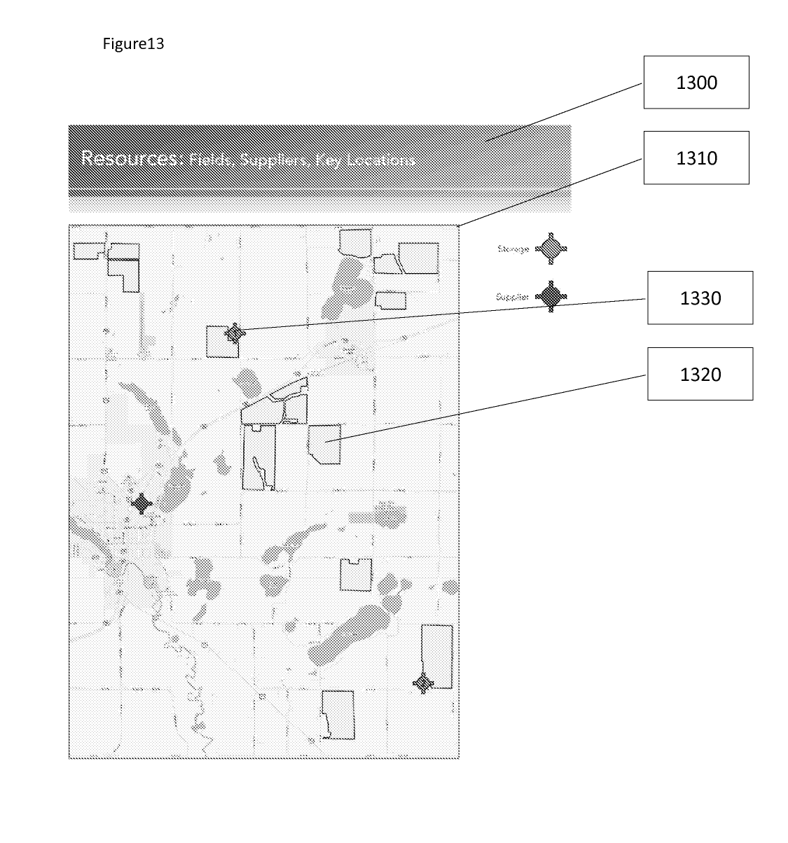

FIG. 13 illustrates an exemplary interactive map GUI 1300. Interactive map GUI 1300 displays a map 1310 of a geographic area. Map 1310 may display various geographic and/or geologic features of a region such as roads and bodies of water. Map 1310 may also display various fields for the harvesting of crops 1320 and structures 1330 that support crop-harvesting operations such as supply depots, equipment depots, fuel depots, suppliers, other facilities, crop depots, buyer locations, and the like. Their locations, functions, capacities, and other relevant data may be used by crop-harvesting plan generator 110 to generate a crop-harvesting plan. In some cases, map 1310 may be interactive such that one or more features present on map 1310 may act as a link to more information regarding the respective feature. For example, information may be displayed in response to selection of a field 1320 or structure 1330 provided on map 1310 as, for example, a pop-up window or a separate GUI page. In some embodiments, user 130 may select a location or region of land and thereby enter, for example, the function, name, size, or location of, for example, a field, depot, resource, supplier, or buyer.

In some embodiments, a user and/or operator may enter information (e.g., GPS coordinates, shape, plot number, and/or common names, or address information) to define the location, size, and shape of a field, a feature of a field, a landmark, or resource (e.g., fuel depot, supply depot, equipment depot). Crop-harvesting plan generator 110 may then use this information to access, for example, one or more databases, such as database 120, data feeds, such as data feed 115, and/or a public or private third party website (e.g., www.noaa.gov, www.usgs.gov, www.usda.gov, www.weather.com) in order to access information regarding the field that may be incorporated into a crop-harvesting plan. In some situations, the crop-harvesting plan generator 110 will have previously gathered data from public and private sources, processed and refined, and then optimized and organized the data in database 120 such that when a user enters the location of a field, the crop-harvesting plan generator 110 may then quickly and automatically access the database 120 to retrieve weather, climate, and geologic data relevant to the field. In some situations, drones or other sensing devices may use the map or information derived from the map to determine from which fields to gather data, determine a flight plan, and control the drone or other sensing device.

On some occasions, information entered via map GUI 1300 may be used by crop-harvesting plan generator 110 to determine one or more transportation routes for supplies, resources, harvested crops, and/or equipment. On other occasions, the crop-harvesting plan generator 110 may use information entered via map GUI 1300 to determine information specific to a field or area of land, such as slope, topography, weather, climate, soil types, organic matter present, soil fertility, and the like.

On some occasions an interactive or static map which is personalized for an individual, role, piece of equipment, supplier and/or buyer may be create by the crop-harvesting plan generator 110. The map may include all of the information contained in a complete map or only those aspects relevant to the duties and responsibilities of that person, piece of equipment, supplier or buyer.

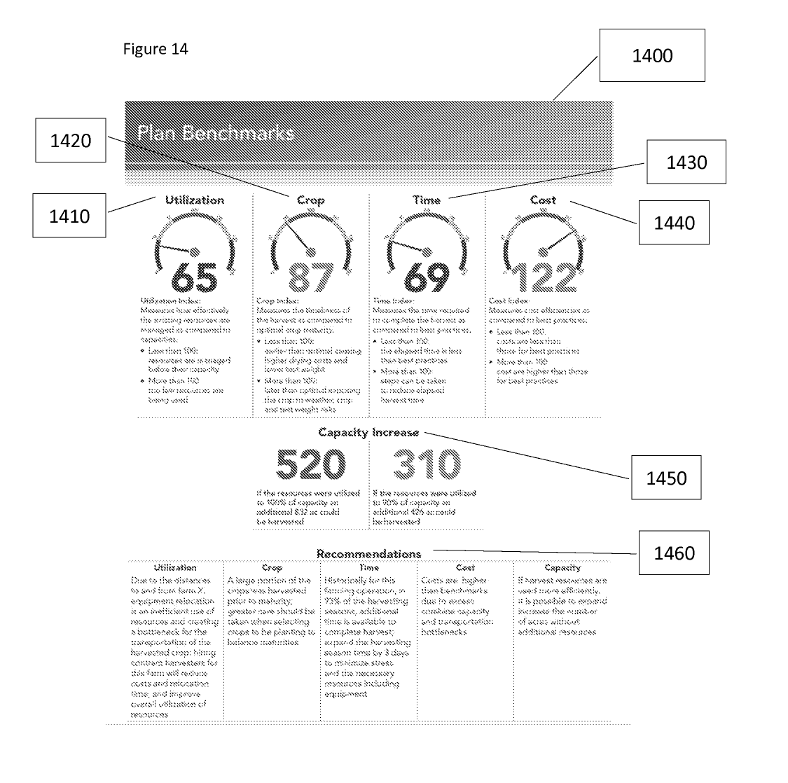

FIG. 14 illustrates an exemplary analysis of crop-harvesting plan in the form of criterion (index) GUI 1400. Crop-harvesting plan index GUI includes a utilization index 1410, a crop index 1420, a time index 1430, a cost index 1440, a capacity measure 1450 and a recommendation table 1460. The indexes may indicate a numerical value or score for the actual, estimated, and/or projected performance of a crop-harvesting plan when executed as compared to a benchmark. The indexes can also be used to compare two or more crop-harvesting plans. In the example provided, indexes 1410-1440 are structured and calibrated to calculate a score between 0-200. The greater the deviation from the benchmark the further the score diverges from a target score of 100. Of course, any method of measurement or presenting measurement results can be used to generate or provide results from these comparisons.

Utilization index 1410 may provide a score indicating how effectively and efficiently the resources available to the user are utilized in the crop-harvesting plan as compared to their capacities. A score between 0 and 99 may indicate that resources are being, or will be, used below their capacity. A score between 101 and 200 may indicate that too few resources are being or will be used to execute the crop-harvesting plan, resulting in resources that are used in excess of their capacities.

Crop index 1420 may provide a score indicating a comparison of the crop condition when actually harvested or scheduled to be harvested against the predetermined or predicted optimal harvesting time (benchmark). In some examples, a crop benchmark may be a targeted crop condition, such as that based on moisture levels, test weight, and/or maturity. In another example, the crop benchmark may be a contractual obligation that was defined by a buyer. A score between 0 and 99 may indicate that crops are, or will be, harvested earlier than the benchmark. A score between 101 and 200 may indicate that crops are being harvested later than the benchmark which may lead to lower crop yields, risk of a killing frost or other weather events, failure to achieve a pricing premium, and/or failure to meet a contractual obligation.

Time index 1430 may provide a score indicating a comparison of the elapsed time required to complete crop harvesting as compared to a benchmark, or targeted time period. A score between 0 and 99 may indicate that the time planned or actually required to complete the harvesting of a crop is, or will be, less that the known best practices or targets. A score between 101 and 200 may indicate that steps can be taken to reduce the total time required to harvest the crops and realize a more preferred score.

Cost index 1440 may provide a score indicating cost effectiveness of a crop-harvesting plan. A score between 0 and 99 may indicate that the cost of harvesting the crop is, or will be, less than known best practices or targeted costs, while a score between 101 and 200 may indicate the opposite.

Capacity increase 1450 may indicate that by using resources more effectively the same resources may have the capability to harvest crops on additional acres thereby expanding the operation without incurring added costs. For example, if the resources required for the execution of the crop-harvesting plan associated with crop-harvesting plan index GUI 1400 were utilized at 100% of capacity, an additional 520 acres could be harvested while if the same resources were utilized at 90% of capacity, an additional 310 acres could be harvested.

On some occasions, GUI 1400 may include a recommendation table 1460. Recommendation table 1460 may include one or more recommendations for modifying the crop-harvesting plan, resulting in improving one or more indexes 1410-1440 and/or capacity increase 1450. For example, utilization index 1410 indicates that the resources available for harvesting crops are under-utilized because the utilization index is below 100. Thus, recommendation table 1460 may provide a utilization recommendation which would result in improving utilization of resources. Recommendation table 1460 may also provide a crop-harvesting recommendation indicating that the crop should be harvested later in the season. In some cases, a utilization recommendation may be more specific, such as “due to the distances to and from farm X, equipment relocation is an inefficient use of resources and creating a bottleneck for the transportation of the harvested crop; hiring contract harvesters for this farm will reduce costs and relocation time, and improve overall utilization of resources.” Recommendation table 1460 may also provide a crop recommendation indicating, for example, “a large portion of the crops was harvested prior to maturity; greater care should be taken when selecting crops to be planted to balance maturities.”

Recommendation table 1460 may further include time, cost, and/or capacity recommendations. An exemplary time recommendation includes “Historically for this farming operation, in 93% of the harvesting seasons, additional time is available to complete harvest; expand the harvesting season time by 3 days to minimize stress and the necessary resources including equipment.” An exemplary cost recommendation includes “costs are higher than benchmarks due to excessive combine capacity and transportation bottlenecks” and an exemplary capacity recommendation includes “if harvesting resources are used more efficiently, it is possible to increase the number of acres without additional resources.”

In one embodiment, recommendation table 1460 may include a recommendation for the purchase, renting, or selling of equipment or resources used to harvest a crop or execute a crop-harvesting plan.

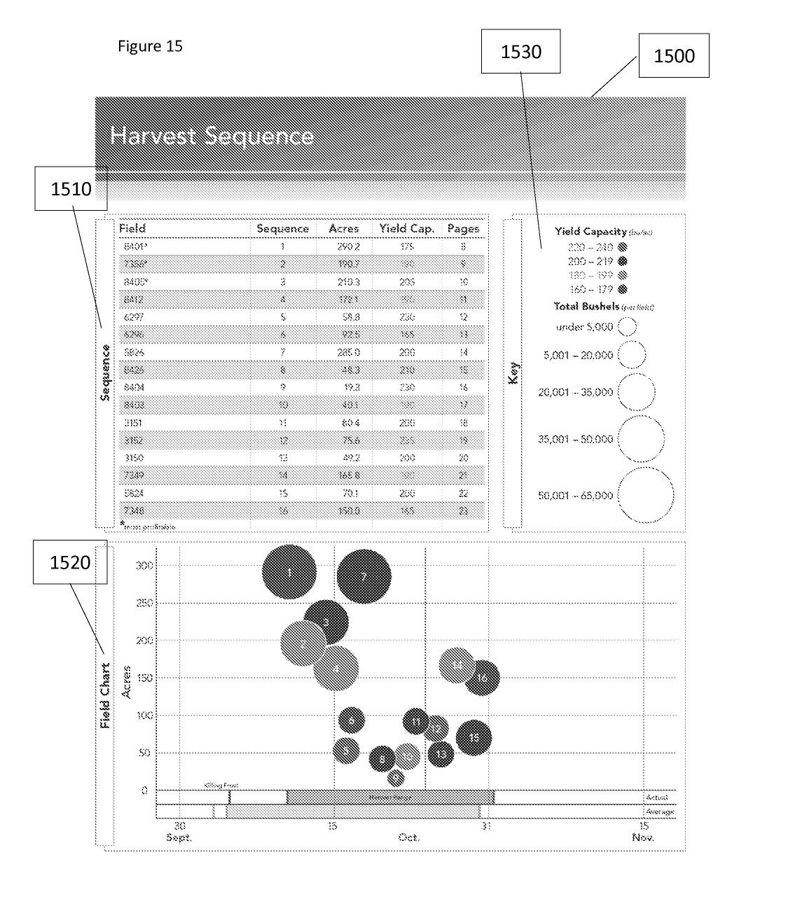

FIG. 15 illustrates an exemplary field detail GUI 1500 that includes a sequence table 1510, a field chart 1520, and a key 1530. Sequence table 1510 may include a list of multiple fields organized and presented according to the sequence in which they should be harvested. The order in which fields are sequenced may be determined by, for example, the crop-harvesting plan generator in response to and by analyzing information provided to the crop-harvesting generator. Key 1530 may provide a key to the information displayed on field chart 1520. Field chart 1520 may graphically display, for example, the total acres of land to be harvested, the yield capacity for a field, the size of a field, and a range of dates and sequence in which the fields are to be harvested in relation to the other fields. In this sample embodiment the objective is to harvest the fields with the greatest potential for yield and profit at their most ideal time and harvest the other fields as per the additional data provided while minimizing unnecessary movement of resources. In some embodiments, the crop-harvesting plan may be updated to include, for example, completed crop-harvesting activities.

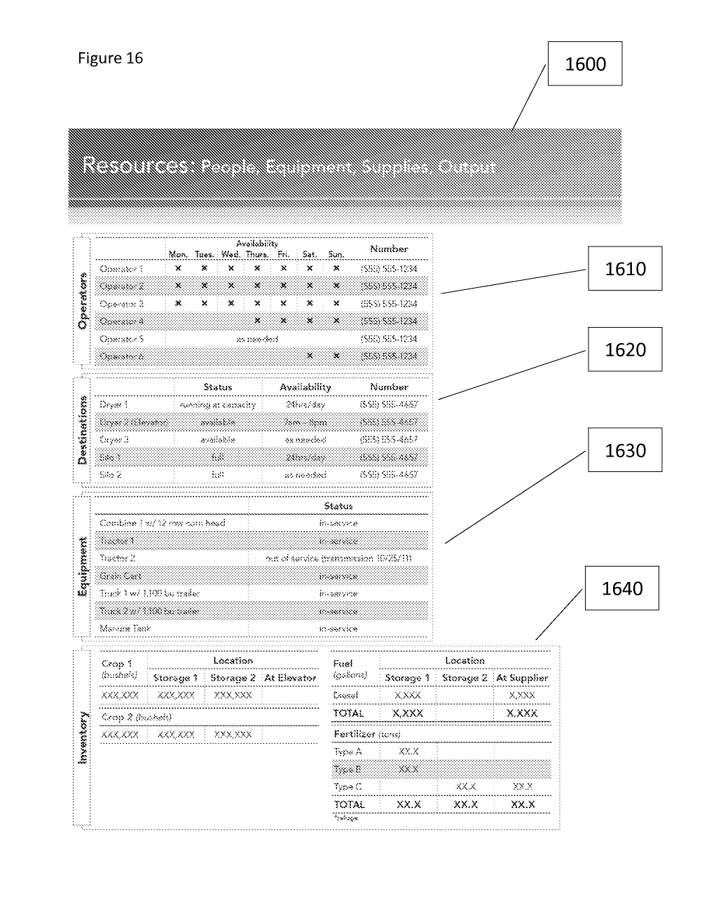

FIG. 16 illustrates an exemplary resources GUI 1600 that includes information relating to equipment and resources available for the harvesting of crops. For example, resources GUI 1600 may include an operators table 1610, a destinations table 1620, an equipment table 1630, and an inventory table 1640. Operators table 1610 may include a list of employees or operators, their skills, hours, availability, and contact information. Destinations table 1620 may include a list of, for example, buyers and/or processing or storage facilities (for example, dryers, elevators, silos, ethanol distilleries, etc.) and/or other destinations and their respective availability and contact information. Equipment table 1630 may include a list of crop-harvesting equipment and its respective status. Inventory table 1640 may include a list of the inventory, in terms of crops already harvested, sold, and delivered to storage, and resources required to complete the harvesting process.

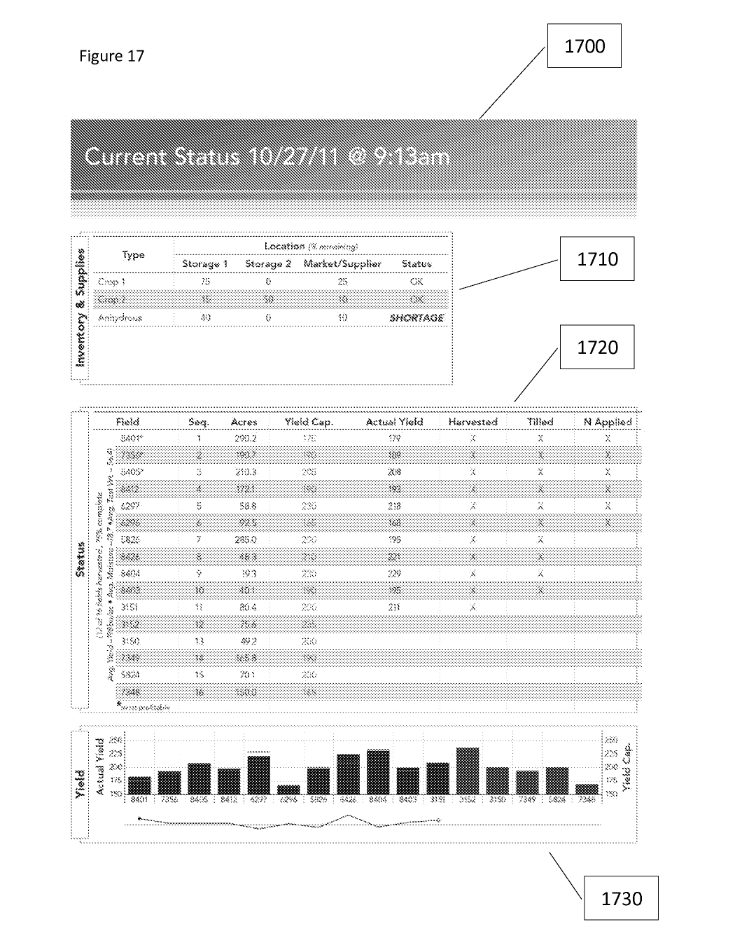

FIG. 17 illustrates an exemplary status GUI 1700 that was created during the crop harvesting season that provides status for a crop-harvesting plan. This type of information can provide the user with an overview of the harvesting activity at any point in time. In this exemplary illustration the crop harvesting plan has been partially completed and the balance of the plan is yet to be completed. In the upper portion of the example the user has an overview of his or her supplies consumed and harvested crops in inventory amassed 1710 including remaining storage capacity, fertilizer, and other supplies and resources, and this table serves as an indicator of which supplies and resources for which there may be a shortage. Status GUI 1700 may also include a status table 1720 that lists, for example, field names or numbers, harvesting sequence, field acreage, yield capacity, actual yield, and the status of a field (e.g., whether a field has been tilled or harvested or whether other inputs have been applied to a field in preparation for the next crop). Yield chart 1730 is an example of graphical display of yield capacity and harvesting sequence. In this example the user can visually review the yield potential of each field, its sequence to be harvested, and the actual achieved yield of those fields already harvested.

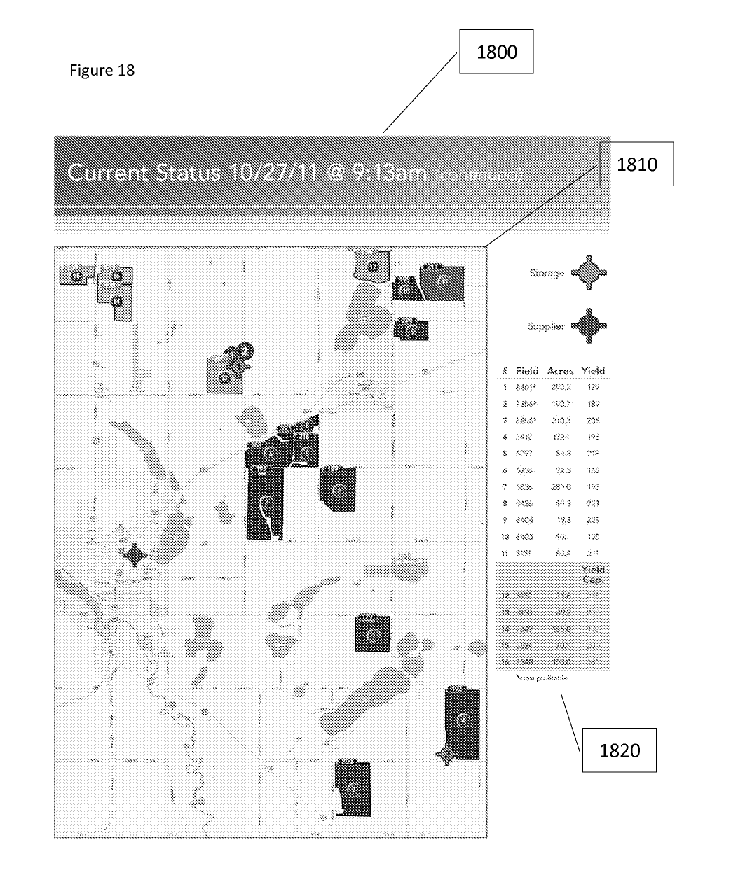

FIG. 18 illustrates an exemplary interactive operational status map GUI 1800. Interactive operational status map GUI 1800 displays a map 1810 of a geographic area. Map 1810 may display an operational status of various crop-harvesting processes and a table 1820 depicting the acreage and either harvested yield or yield capacity of a field. Map 1810 may also include representations of one or more fields. In some embodiments, status map GUI 1800 may be dynamically updated with, for example, updated crop harvesting information as it becomes available.

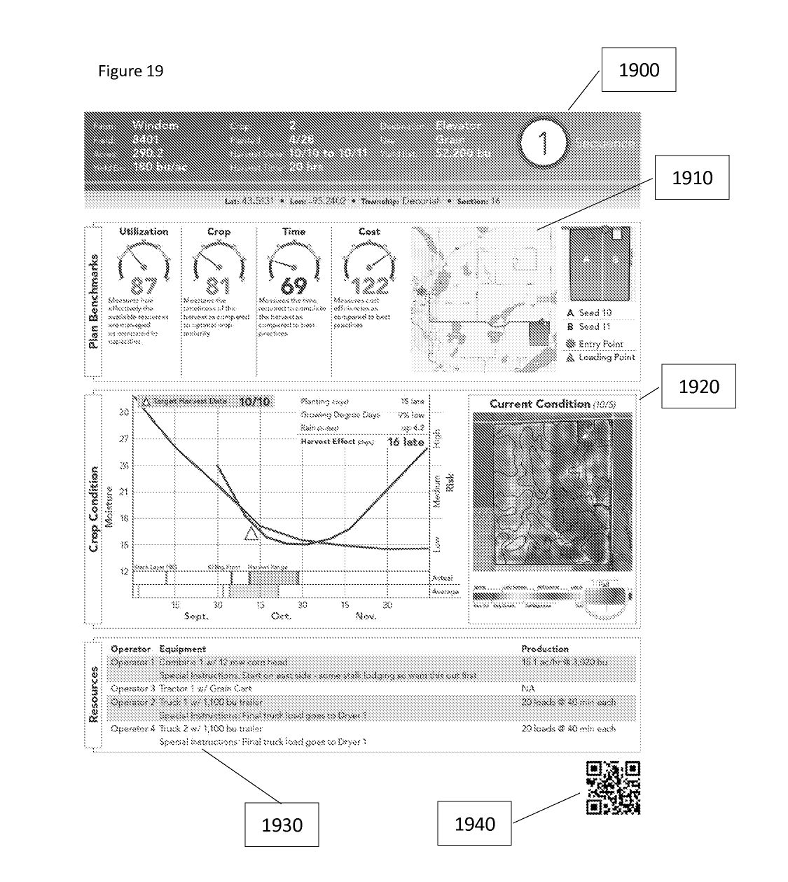

FIG. 19 illustrates an exemplary summary GUI 1900 that includes crop-harvesting plan for one specific field. This example is site-specific, field-specific. The complete crop-harvesting plan is a combination of all of these individual field plans. The example GUI 1900 includes the same criterion indexes as those used to measure and benchmark the entire crop-harvesting plan except they are limited to a specific field.

The exemplary GUI 1900 contains a map 1910 which illustrates the crop delivery location as well as the route to transport the crop from the field to that location. In addition, this map illustrates the type and planting location of the seed(s), the field entry point, and the specific location where the crop will be transferred from the harvesting equipment to the transportation equipment. The crop condition section 1920 of this exemplary GUI illustrates the predicted optimal time to harvest the crop as determined by the crop-harvesting plan generator. In this example, the planting date as well as the elapsed growing degree days (GDDs) are used to determine the recommended harvest date, as displayed on the graph. The crop condition section 1920 also displays a satellite image illustrating the crop condition and variations in crop maturity across the field. In this example, harvest maturity is based on an analysis of weather, imagery, remote sensing, crop characteristics, seed type, as well as other data. In another scenario in which the user has a contractual obligation with a buyer, the buyer's terms would also be factored into the algorithm used to calculate the recommended harvesting date.

The resources section 1930 defines the personnel and equipment used to execute the crop-harvesting plan for this field. Special instructions for the personnel are also included for one or more equipment operators, and/or employees working in conjunction with user 130 and/or manager 145 to harvest crops on this field.

Exemplary summary GUI 1900 also contains a machine-readable bar code 1940. This code contains all of the instructions necessary for the execution of the crop-harvesting plan in a form in which the data can be easily directly transferred into the electronic devices used on the harvesting and transportation equipment and devices used by the personnel. The bar code used in this example is but one method that can be used to transfer the instructions directly from the crop-harvesting plan generator 110 into the electronic devices of the equipment, such as equipment 150, used by the personnel. Other methods of transferring instructions include wireless communications or direct information transfer via, for example, a memory stick or mobile phone.

In some embodiments, crop-harvesting plans may “broken down” into personalized plans for an individual person or piece of equipment. These plans may be personalized, for example, for one or more equipment operators, and/or employees working in conjunction with user 130 and/or manager 145 to harvest crops on the fields. Personalized management plans may be generated and/or customized for execution of some or all of a crop-harvesting plan and may include specific instructions for an individual including their roles and responsibilities as well as schedules, instructions, and maps concerning how and when to execute a portion of a crop-harvesting plan. All of the personalized plans may be dynamically updated with, for example, updated crop-harvesting information as it becomes available.

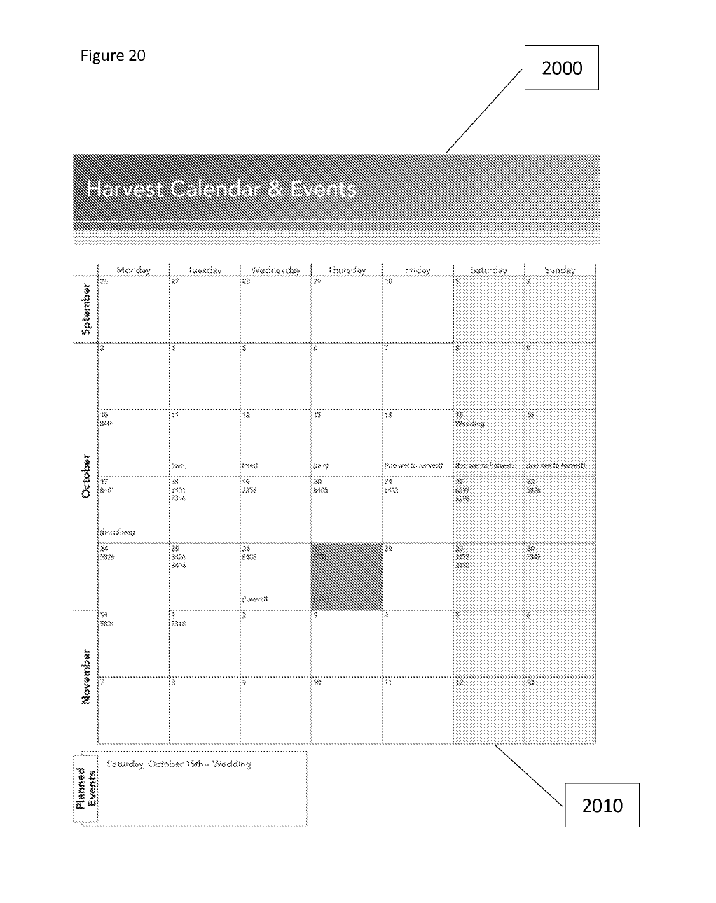

An individualized plan may be provided to user 130, manager 145, equipment operators, and/or employees via, for example a user interface, such as user interface 125 and/or a management interface, such as management interface 140 as, for example, one or more GUIs, examples of which are provided in FIGS. 20-22B. For example, field-harvesting sequence GUI 2000, as depicted in FIG. 20, where a schedule or calendar is used to communicate instructions 2010 for tasks to be performed when implementing a crop-harvesting plan. In some embodiments, user 130, manager 145, an equipment operator, and/or an employee may enter an event or equipment status update and the crop-harvesting plan may incorporate the new data into the plan. For example, as shown in FIG. 20, a planned event, in this case a wedding has been entered as occurring on Saturday, October 15th and consequently no crop-harvesting activity has been scheduled for this individual for this day. Calendar 2010 may also include other planned events, such as deadlines, resource availability, and contractual obligations. In this way, a management and/or crop-harvesting plan may be customized to accommodate a scheduling need of, for example, user 130, manager 145, an equipment operator, and/or an employee.

Field-harvesting sequence GUI 2000 may also provide a sequence of crop-harvesting activities that are to take place and, on some occasions, the respective dates for doing so. For example, calendar 2010 indicates that crops are to be harvested on field 8401 on October 17th and 18th and crops are to be harvested on field 5824 on October 31st. Calendar 2010 may also display various other events, such as make-up days or days when no crop-harvesting activities are scheduled.

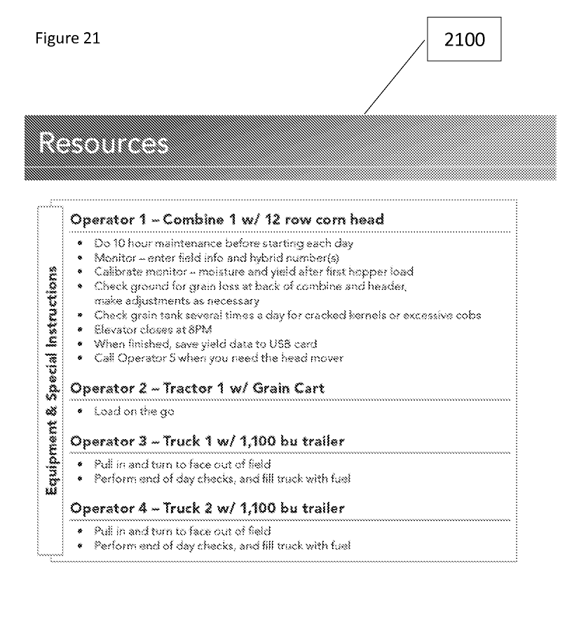

FIG. 21 displays a sample including a summary of instructions for personnel resources GUI 2100 that includes information, instructions, and/or recommendations regarding their activities. For example, resource instruction GUI 2100 may display instructions for a combine operator and/or a truck operator. These instructions reflect the responsibilities and activities of a person or group of people which when all executed properly result in achieving the targeted outcomes.

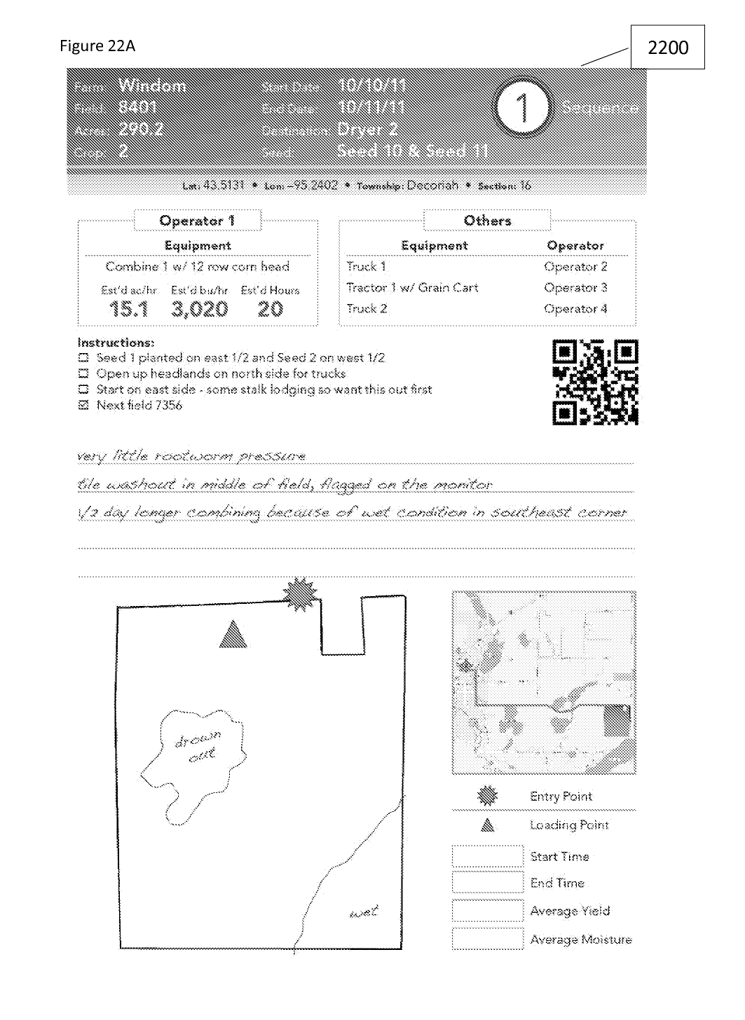

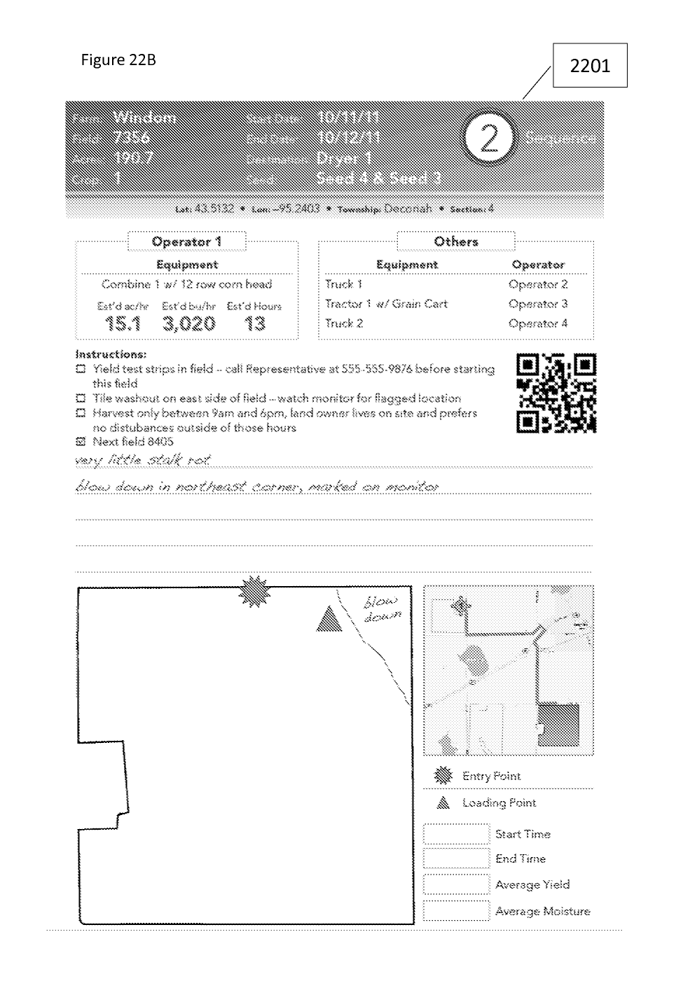

FIGS. 22A-22B display exemplary field-harvesting GUIs 2200-2201 for a particular individual and a specific field that may include instructions for the use of equipment available. Field-harvesting GUIs 2200-2201 may also include a map, interactive or otherwise, that indicates a location of a field upon which the crop may be harvested. On some occasions, the map may include details specific to the field, such as areas that are saturated with water or that require special handling.

In some embodiments, field-harvesting GUIs 2200-2201 may include notes or other information entered by, for example, user 130, manager 145, and/or an equipment operator that is harvesting the crop, such as field location, crop-harvesting start and end times, and other specifics. Other examples are routes for equipment and/or employees to be deployed in order to execute the crop-harvesting plan.

In some embodiments, field-harvesting GUIs 2200-2201 may be provided to user 130, manager 145, and/or an equipment operator as a sequence of instructions which may or may not be field-specific.

Although the exemplary crop-harvesting plan and management plan discussed with reference to FIGS. 12-22B relate to the harvesting of a grain, such as corn, it should be understood that the systems, apparatus, and processes disclosed herein may be applied to any type of crop including, for example, soybeans, wheat, silage, hay, cotton, sorghum, rice, sugar beets, and grapes for wine production.

Thus, methods, apparatus, and systems for generating a crop-harvesting plan and updating a crop-harvesting plan have been herein disclosed.

What is claimed is:

1. A method comprising:
receiving, by a crop-harvesting plan generator that includes a memory and a processor, crop information regarding harvesting crops from at least one of a user, a manager, a database, and a data feed;
receiving, by the crop-harvesting plan generator, image data from a remote sensor;
determining crop moisture levels using the image data;
determining, by the crop-harvesting plan generator, a crop maturity level using the crop moisture levels;
determining, by the crop-harvesting plan generator, plan scores using the crop information and crop moisture levels;
automatically generating, by the crop-harvesting plan generator, one or more crop-harvesting plans for harvesting crops in one or more fields using the plan scores; and
automatically providing, by the crop-harvesting plan generator, the crop-harvesting plan to the user via the communication network.

2. The method of claim 1, further comprising:
receiving, by the crop-harvesting plan generator, additional information regarding the crop-harvesting plan from at least one of the user, the database, the data feed, and the remote sensor;
automatically updating, by the one or more scoring matrices of the crop-harvesting plan generator, the crop-harvesting plan based upon the received additional information; and
providing, by the crop-harvesting plan generator, the updated crop-harvesting plan to the user via the communication network.

3. The method of claim 1, wherein the received information regards a crop-harvesting outcome, the method comprising:
determining, by the crop-harvesting plan generator, a best practice for the harvesting of a crop based on the crop-harvesting outcome; and
automatically updating, by the crop-harvesting plan generator, the crop-harvesting plan responsively to the determined best practice.

4. The method of claim 1, wherein the received information includes information regarding at least one of a planned event, an unplanned event, a contractual requirement, a crop requirement, a harvesting requirement, local knowledge, operational profitability, resource availability, remotely sensed information, information received via a resource, and information received via a computer-implemented social network.

5. The method of claim 4, wherein the received information includes at least one of climate data, historical weather data, current weather data, and predicted weather data, the method further comprising:
automatically updating, by the crop-harvesting plan generator, the crop-harvesting plan as climate data, historical weather data, current weather data, and predicted weather data is received.

6. The method of claim 5, wherein the received information includes remotely sensed data relating to the crops positioned at various locations, the method further comprising:
automatically determining, by the crop-harvesting plan generator, a condition of the crop positioned at the various locations based upon an analysis of the remotely sensed data;
automatically determining, by the crop-harvesting plan generator, a sequence of crop-harvesting locations based on the determined condition of the crops located thereon; and
automatically incorporating, by the crop-harvesting plan generator, the sequence of crop-harvesting locations into the crop-harvesting plan.

7. The method of claim 6, wherein the received information includes remotely sensed data obtained by unmanned aircraft systems relating to the fields positioned at various locations, the method further comprising:
automatically determining, by the crop-harvesting plan generator, a condition of the fields positioned at the various locations based upon an analysis of the remotely sensed data;
automatically determining, by the crop-harvesting plan generator, a sequence of crop-harvesting locations based on the determined condition of the fields located thereon; and
automatically incorporating, by the crop-harvesting plan generator, the sequence of crop-harvesting locations into the crop-harvesting plan.

8. The method of claim 6 wherein the received information includes data obtained from a piece of equipment utilized to execute a portion of the crop-harvesting plan and the crop harvesting plan is automatically updated by the crop-harvesting plan generator.

9. The method of claim 1, further comprising:
identifying, by the crop-harvesting plan generator, an attribute of the received information;
incorporating, by the crop-harvesting plan generator the received information into the identified attribute; and
selecting and providing to the user a plurality of crop-harvesting plans that include multiple attributes.

10. The method of claim 9, wherein the multiple attributes include land available to execute the crop-harvesting plan, resources available to execute the crop-harvesting plan, type of crop to be harvested, local knowledge regarding crop-harvesting, planned events, unplanned events, remotely sensed crop and/or field condition, visually sensed crop and/or field condition, and weather data.

11. the method of claim 1, further comprising;
determining, by the crop-harvesting plan generator, an impact of utilizing a resource to execute a portion of the crop-harvesting plan;
automatically providing a recommendation based upon the determined impact of the utilization to the user by the crop-harvesting plan generator;
determining, by the crop-harvesting plan generator, a potential impact resulting from adding, removing, or altering the utilization of a resource to execute a portion of the crop-harvesting plan; and
automatically providing an analysis based upon the determined potential impact of the change of the utilization of the resource to the user by the crop-harvesting plan generator.

12. The method of claim 1, further comprising:
automatically evaluating, by the crop-harvesting plan generator, the one or more crop-harvesting plans according to one or more criterion;
calculating an evaluation score for each crop-harvesting plan according to the evaluation, wherein the crop-harvesting plans are ranked according to their evaluation score; and
automatically selecting, by the crop-harvesting plan generator, a selected crop-harvesting plan based upon the evaluation.

13. The method of claim 1, wherein determining, by the crop-harvesting plan generator, the plan scores using the crop information and the crop moisture levels comprises determining, by the crop-harvesting plan generator using at least one scoring matrix implemented in the memory, the plan scores.

14. The method of claim 13, further comprising:
receiving, by the crop-harvesting plan generator, additional information regarding at least one of supplier and buyer data for at least one of availability, new orders, modified orders, instructions, delivery, and schedules to execute the crop-harvesting plan;
incorporating, by the crop-harvesting plan generator, the supplier and/or buyer data into the crop-harvesting plan; and
updating, by the crop-harvesting plan generator, the crop-harvesting plan as new supplier and/or buyer data is received.

15. The method of claim 14, wherein a portion of the crop-harvesting plan is provided to at least one of a supplier and buyer executing a portion of the crop-harvesting plan via the communication network.

16. The method of claim 1, further comprising:
monitoring, by the crop-harvesting plan generator, execution of the crop-harvesting plan;
determining, by the crop-harvesting plan generator, a status for one or more resources utilized to execute the crop-harvesting plan or an activity included in the crop-harvesting plan;
providing, by the crop-harvesting plan generator, an alert to the user responsively to the determined status;
generating, by the crop-harvesting plan generator, a set of instructions for execution of a portion of the crop-harvesting plan; and
providing, by the crop-harvesting plan generator, the set of instructions to at least one of the user, the manager, the database, the data feed, the remote sensor, and a piece of equipment utilized to execute the portion of the crop-harvesting plan.

17. The method of claim 16, further comprising
personalizing the set of instructions for at least one of the user, the manager, the database, the data feed, the remote sensor, and the piece of equipment utilized to execute the portion of the crop-harvesting plan; and
providing a portion of the crop-harvesting plan to a person or resource executing a portion of the crop-harvesting plan, including a manager, an employee, a supplier, and a buyer via the communication network.

18. A system comprising:
a crop-harvesting plan generator that includes a memory and a processor;
a data input configured to receive crop moisture levels from at least one of a remote sensor and an unmanned aircraft system, wherein the crop moisture levels are determined using image data obtained by the at least one of the remote sensor and the unmanned aircraft system, and wherein the crop-harvesting plan generator is configured to determine a crop maturity status using the crop moisture levels;
one or more scoring matrices implemented on the memory, wherein the crop-harvesting plan generator is configured to automatically generate, utilizing the one or more scoring matrices, one or more crop-harvesting plans for harvesting a crop in a field using at least the crop maturity status; and
a data output configured to provide the one or more crop-harvesting plans to a user interface via a communication network, wherein the user interface is configured to output the one or more crop-harvesting plans to the user.

19. The system of claim 18, wherein a database implemented on the memory stores crop information received from at least one of a user, a manager, a data feed, the database, and social network, and wherein the database stores the crop-harvesting plan and wherein the crop information includes field data, resource data, crop data, logistical data, climate data, supplier data, buyer data, and insurance data.

20. A tangible, non-transitory computer-readable media including a set of instructions stored thereon which when executed by a computer enable the computer to receive information regarding crop-harvesting from at least one of a user, a manager, a database, and a data feed, and crop moisture levels from a remote sensor via a communication network, generate a crop maturity status using the crop moisture levels, generate a plurality of crop-harvesting plans for harvesting seeds using the received information and the crop maturity status, evaluate the plurality of crop-harvesting plans according to one or more criterion, calculate a score for each crop-harvesting plan according to the evaluation, wherein the crop-harvesting plans are ranked according to their score as compared to a benchmark, select a crop-harvesting plan responsively to the evaluation, and provide the crop-harvesting plan to the user via the communication network, wherein the crop moisture levels are determined using image data obtained by the remote sensor.
